(19) United States
(12) Patent Application Publication
(10) Pub. No.: US 2025/0231523 A1
(43) Pub. Date: Jul. 17, 2025

(54) CONTAINER AND METHOD FOR MANUFACTURING CONTAINER

(71) Applicant: CANON KABUSHIKI KAISHA, Tokyo (JP)

(72) Inventors: RYOJI KUSUDO, Kanagawa (JP); AKIRA SUZUKI, Kanagawa (JP); YUUSUKE SAITO, Kanagawa (JP); RYO NISHIMURA, Kanagawa (JP); SHINJIRO TOBA, Kanagawa (JP); TSUYOSHI OGAWA, Tokyo (JP)

(21) Appl. No.: 19/170,945

(22) Filed: Apr. 4, 2025

Related U.S. Application Data
(63) Continuation of application No. PCT/JP2023/037102, filed on Oct. 12, 2023.

(30) Foreign Application Priority Data
Oct. 13, 2022 (JP) 2022-165011
Apr. 6, 2023 (JP) 2023-062419

(51) Int. Cl. G03G 21/18; G03G 15/08; G03G 21/00; G03G 21/16

(52) U.S. Cl. CPC G03G 21/1821; G03G 15/0808; G03G 15/0865; G03G 21/007; G03G 21/1647; G03G 21/1814

(57) ABSTRACT

A container includes: a first frame body having an opening portion and a first surface; a second frame body connected to the first frame body and forming an storage portion together with the first frame body, the second frame body having a second surface facing the first surface; and a connection member connecting the first frame body and the second frame body, in which a protruding portion is provided on one of the first surface and the second surface, a recessed portion is provided on the other, the protruding portion is inserted into the recessed portion so that a tip surface of the protruding portion and a bottom surface of the recessed portion are not in contact with each other, and the connection member is provided between the protruding portion and the recessed portion so as to be in contact with the tip surface and the bottom surface.

### CROSS-REFERENCE TO RELATED APPLICATIONS

This application is a Continuation of International Patent Application No. PCT/JP2023/037102, filed Oct. 12, 2023, which claims the benefit of Japanese Patent Applications No. 2022-165011, filed Oct. 13, 2022, and No. 2023-062419, filed Apr. 6, 2023, both of which are hereby incorporated by reference herein in their entirety.

### BACKGROUND OF THE INVENTION

### Field of the Invention

The present disclosure relates to a unit provided in an image forming apparatus, such as a copying machine or a printer, which employs an electrophotographic system.

### Background Art

As a configuration of an image forming apparatus, there is a case where a process cartridge system is employed in which a photosensitive drum (image bearing member) or a process unit and a developer container acting thereon are integrally formed into a cartridge and this cartridge is detachably attached to a main body of the image forming apparatus. Examples of the cartridge include a developing unit having a developing sleeve (developer bearing member) and a developing blade (developer regulating member), and a photosensitive unit having a photosensitive drum and a cleaning blade (cleaning member). These units are provided with a frame body for supporting each process member, and the frame body is provided with a storage portion for toner (developer). For example, in a full-color printer or the like in which a plurality of process cartridges is removably attached to the same image forming apparatus main body, a unit frame body may be prepared in which the capacity of the toner storage portion differs for each unit depending on the frequency of use or the like.

The unit frame, which is also a developer container, is divided into a plurality of frame bodies and integrally formed by a connection method such as ultrasonic welding. As the connection method, a method has been proposed in which an uneven portion is formed at the connection portion of each frame and a gap is fixed with an adhesive (PTL 1). Also, a method has been proposed in which the frame bodies are fixed to each other by a mold and a molten resin is poured into a gap formed in the connection portion to join them with resin.

Also, configurations described in such as PTL 2 to PTL 4 have been proposed as snap-fit configurations for joining.

The present invention further has developed the above-described prior art.

### CITATION LIST

### Patent Literature

PTL 1 Japanese Patent Application Publication No. 2020-134690
PTL 2 Japanese Patent Application Publication No. H08-146859
PTL 3 Japanese Patent Application Publication No. H08-211815
PTL 4 Japanese Patent No. 2877540

### SUMMARY OF THE INVENTION

To achieve the above object, a container according to the present invention is directed to
a container for containing developer, the container including:
a first frame body provided with an opening portion, the first frame body having a first surface extending along an edge of the opening portion;
a second frame body connected to the first frame body so as to cover the opening portion and forming a storage portion for storing developer together with the first frame body, the second frame body having a second surface facing the first surface and extending along a direction in which the first surface extends; and
a connection member connecting the first frame body and the second frame body,
   wherein
one of the first surface and the second surface is provided with a protruding portion, an other of the first surface and the second surface is provided with a recessed portion,
wherein the protruding portion is inserted into the recessed portion so that a tip surface of the protruding portion and a bottom surface of the recessed portion are not in contact with each other, and
wherein the connection member is provided between the protruding portion and the recessed portion so as to contact both the tip surface of the protruding portion and the bottom surface of the recessed portion.

To achieve the above object, a method for manufacturing a container according to the present invention is directed to
a method for manufacturing a container, the container including a first frame body provided with an opening portion, the first frame body having a first surface extending along an edge of the opening portion, and a second frame body connected to the first frame body so as to cover the opening portion and forming a storage portion for storing developer together with the first frame body, the second frame body having a second surface facing the first surface and extending along a direction in which the first surface extends, a protruding portion being provided on one of the first surface and the second surface, and a recessed portion being provided on an other of the first surface and the second surface, the method including:
a supply step of supplying a molten resin to the recessed portion;
a moving step of moving at least one of the first frame body and the second frame body so that a tip surface of the protruding portion is immersed in the molten resin in the recessed portion, the moving step being subsequent to the supply step; and
a curing step of curing the molten resin, the curing step being subsequent to the moving step.

Further features of the present invention will become apparent from the following description of exemplary embodiments with reference to the attached drawings.

### BRIEF DESCRIPTION OF THE DRAWINGS

FIGS. 1A to 1C are cross-sectional views of a joint portion showing a joint configuration of a frame according to a first embodiment.

FIG. 2 is a cross-sectional view showing a schematic configuration of an image forming apparatus.

FIGS. 3A and 3B are perspective views of an appearance of a process cartridge.

FIG. 4 is a cross-sectional view of the process cartridge.

FIG. 5 is a perspective view showing a structure in which the process cartridge is attached to and detached from the image forming apparatus.

FIG. 6 is a cross-sectional view showing a frame structure of a developing unit.

FIGS. 7A and 7B are external views showing a joint portion of a developing frame body.

FIG. 8 is a perspective view showing the assembly of a developing cover to a developer container.

FIG. 9 is a perspective view showing the attachment of a cleaning member to the developer container.

FIGS. 10A and 10B are perspective views showing a frame configuration of the developing unit.

FIG. 11 is a perspective view showing a state where a connection member is applied to the developing cover.

FIGS. 12A to 12C are partial perspective views showing a method of fixing the developing cover to a developer container.

FIGS. 13A to 13C are partial perspective views showing a method of fixing the developing cover to the developer container.

FIGS. 14A to 14C are partial perspective views showing a method of fixing the developing cover to the developer container.

FIG. 15 is a cross-sectional view of a joint portion showing a joint configuration of a frame body according to a second embodiment.

FIG. 16 is a cross-sectional view showing a frame configuration of a cleaning unit.

FIGS. 17A and 17B are external views showing a frame configuration of a cleaning frame.

FIG. 18 is a perspective view showing the attachment of a developer regulating member to a developer container.

FIG. 19 is a perspective view showing the configuration of a developing subunit.

FIGS. 20A and 20B are perspective views showing the attachment of a cleaning cover to a cleaning container.

FIGS. 21A to 21C are partial perspective views showing a method of fixing the cleaning cover to the cleaning container.

FIG. 22 is an external perspective view of the cleaning unit.

FIGS. 23A and 23B are perspective views showing a frame configuration of a toner cartridge.

FIG. 24 is a cross-sectional view illustrating a connection configuration of a toner frame member.

FIGS. 25A to 25D are illustrative views of a second positioning boss.

FIGS. 26A to 26D are illustrative views of a fixing portion.

FIG. 27 is an external perspective view of a developing unit according to a fifth embodiment.

FIGS. 28A and 28B are illustrative views of snap-fit of the developing unit.

FIGS. 29A to 29D are illustrative views of snap-fit of the developing unit.

FIGS. 30A and 30B are illustrative views of snap-fit of the developing unit.

FIG. 31 is an external perspective view of the developing unit according to a sixth embodiment.

FIG. 32 is an illustrative view of snap-fit of the developing unit.

FIG. 33 is an illustrative view of snap-fit of the developing unit.

FIGS. 34A to 34C are illustrative views of hot-melt scraping.

FIG. 35 is an illustrative view of the hot-melt scraping.

FIG. 36 is an external perspective view of a cleaning unit.

FIGS. 37A and 37B are illustrative views of snap-fit of the cleaning unit.

FIGS. 38A and 38 are illustrative views of snap-fit of the cleaning unit.

FIGS. 39A to 39D are illustrative views of snap-fit of the cleaning unit.

### DESCRIPTION OF THE EMBODIMENTS

In the following examples, embodiments in the present disclosure will be described by way of example. However, the configurations disclosed in the following embodiments, for example, the function, material, shape, and relative arrangement of the components illustrate examples of modes related to the claims, and do not intend to limit the claims to the configurations disclosed in these embodiments. Also, the problems or effects achieved by the arrangements disclosed in the following examples or from the disclosed arrangements are not intended to limit the scope of the claims.

### First Embodiment

An electrophotographic image forming apparatus according to a first embodiment of the present disclosure will now be described with reference to the accompanying drawings. Here, an electrophotographic image forming apparatus (hereinafter referred to as an image forming apparatus) forms an image on a recording material by using an electrophotographic image forming method. Examples of image forming apparatuses include an electrophotographic copying machine, an electrophotographic facsimile apparatus, an electrophotographic printer (laser printer, LED printer, etc.), and composite machines (multi-function printers), electrophotographic word processors, and the like. As a recording material, a sheet-like recording medium such as a recording paper or a plastic sheet is included.

The image forming apparatus according to the present embodiment is an image forming apparatus employing a so-called cartridge system. The cartridge is a unit that is attachable to and detachable from the image forming apparatus and includes a photosensitive member and a process unit (for example, a charging member, a developing member, a cleaning member, etc.) acting on the photosensitive member.

In the following embodiments, a mono-color laser printer to which one process cartridge (cartridge) is attachable and detachable is illustrated as an image forming apparatus. Note that the number of process cartridges to be mounted on the image forming apparatus is not limited to this, and for example, in a full-color laser printer, a plurality of process cartridges having different colors from each other are removably configured.

### Overview of Entire Laser Printer

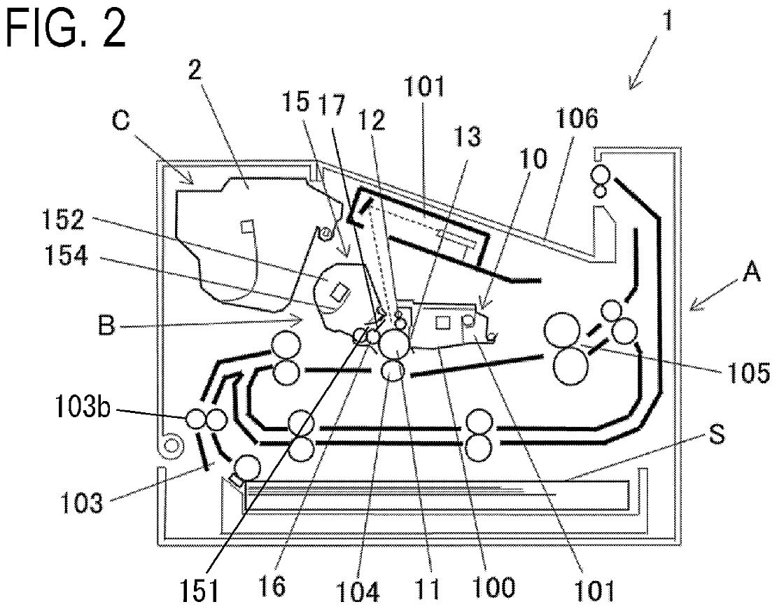

FIG. 2 is a schematic cross-sectional view illustrating a schematic configuration of a laser printer that is an example of the image forming apparatus according to the present embodiment. As illustrated in FIG. 2, in a laser printer 1, a sheet feeding portion 103, a transfer roller 104, a fixing portion 105, and a laser scanner 101 are installed in a printer main body (image forming apparatus main body) A. Further, a process cartridge B and a toner cartridge C are removably disposed on the printer body A.

The process cartridge B includes a cleaning unit 10 (first unit) including a photosensitive drum 11 as an image bearing member and a developing unit 15 (second unit) including a developing roller 16 as a developer bearing member that bears developer (toner).

The cleaning unit 10 includes the above-described photosensitive drum 11, a charging roller 12 as a charging member, a cleaning blade 13 as a cleaning member, a waste toner primary storage portion 100, and a waste toner conveyance path (not illustrated). The photosensitive drum 11 is rotatably provided in a frame body (cleaning frame body) of the cleaning unit 10, and rotates by receiving a driving force of a motor (not illustrated) provided in the printer body A. The charging roller 12 is disposed so as to be in contact with an outer peripheral surface of the photosensitive drum 11, and charges the photosensitive drum 11 by voltage application from a printer main body (apparatus main body) A. Also, the charging roller 12 is rotatably provided in the cleaning frame member, and rotates following the rotating photosensitive drum 11. The cleaning blade 13 is an elastic member disposed so as to be in contact with an outer peripheral surface of the photosensitive drum 11. A tip of the cleaning blade 13 elastically contacts the photosensitive drum 11, so that the toner remaining on the photosensitive drum 11 after a sheet S as a recording material to be described later passes between the photosensitive drum 11 and the transfer roller 104 is removed from the photosensitive drum 11. The removed toner (waste toner) is conveyed from a waste toner primary storage portion 100 to be described later to the toner cartridge C through a waste toner conveyance path (not illustrated).

The developing unit 15 includes a developing chamber 151 in which the developing roller 16 is rotatably disposed, and a developer storage chamber 152 for supplying a toner to the developing chamber 151. The developing roller 16 supplies the toner to a developing area of the photosensitive drum 11. The developing roller 16 develops an electrostatic latent image formed on the photosensitive drum 11 using toner (developer). A developing blade 17 contacts a peripheral surface of the developing roller 16 to define the amount of toner adhered to the peripheral surface of the developing roller 16 (regulates the thickness of a layer of the toner). Also, Triboelectric charges are imparted to the toner. The toner stored in the developer storage portion (developer storage chamber) 152 is sent out to the developing chamber 151 by the rotation of the stirring member 154 and supplied to the developing roller 16. Upon detection that the amount of the toner in the developer storage chamber 152 has become equal to or less than a predetermined amount by a residual amount detection unit (not shown), the toner is supplied from the toner cartridge C to the process cartridge B.

The toner cartridge C has a toner supply portion 2 for supplying the toner to the process cartridge B and a waste toner collecting portion (not shown) for collecting the waste toner from the process cartridge B.

The process cartridge B and the toner cartridge C are attachable to and detachable from the printer body A.

### Operation of Laser Printer

The photosensitive drum 11 rotationally driven by a driving source (not illustrated) is uniformly charged to a predetermined potential by the charging roller 12. A surface of the charged photosensitive drum 11 is subjected to image exposure based on image information by the laser scanner 101, and the charge of the exposed portion is removed to form an electrostatic latent image. An electrostatic latent image on the photosensitive drum 11 is visualized as a toner image by supplying the toner from the developing roller 16.

On the other hand, the sheet S is conveyed along the sheet feeding portion 103 in parallel with the toner image forming operation. Specifically, a feeding roller 103b rotates to feed the sheet S. Thereafter, the sheet S is also conveyed to a transfer portion at the same timing when the toner image on the photosensitive drum 11 reaches the transfer portion between the photosensitive drum 11 and the transfer roller 104. When the sheet S passes through the transfer portion, the toner image is transferred to the sheet S as an unfixed image by applying a bias to the transfer roller 104. Thereafter, the sheet S to which the toner image has been transferred is conveyed to the fixing portion 105. While the sheet S conveyed to the fixing portion 105 passes through the fixing portion 105, the unfixed image is heated and pressed to be fixed on the surface of the sheet S. Thereafter, the sheet S is further conveyed by the sheet feeding portion 103, and discharged and stacked on the discharge tray 106.

### Outline of Process Cartridge

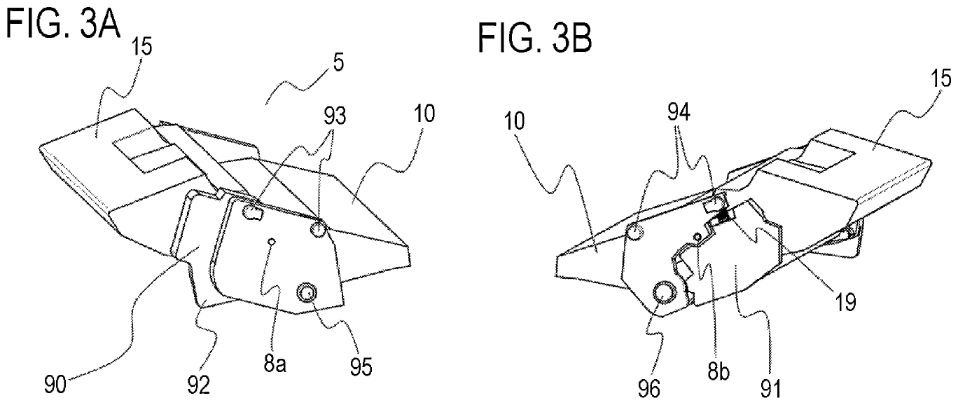

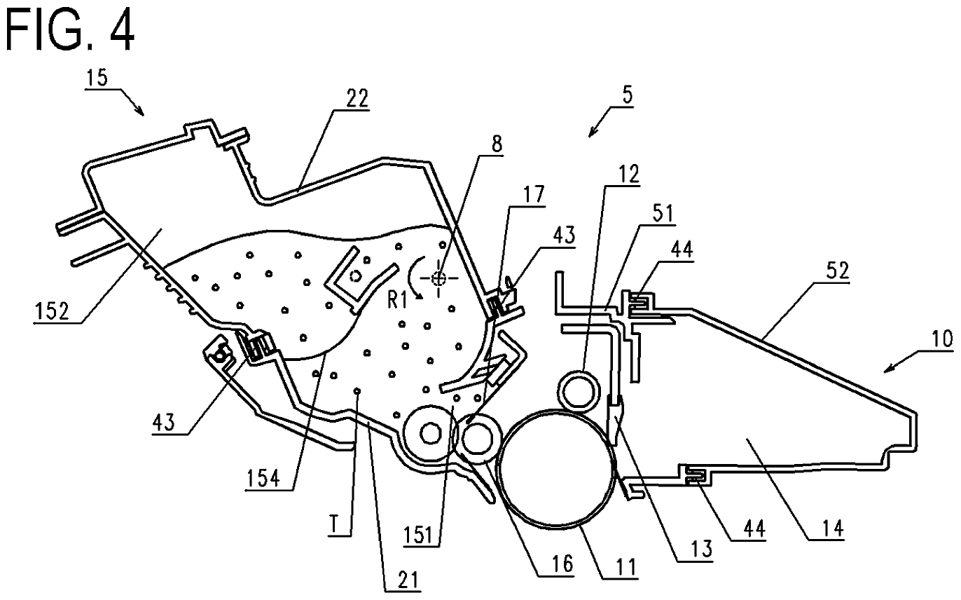

A configuration of the process cartridge 5 in the present embodiment will be described in detail with reference to FIGS. 3 and 4. FIG. 3 is an external perspective view of the process cartridge 5, in which FIG. 3A is a schematic perspective view of one side of the process cartridge 5 in a direction perpendicular to the paper surface of FIG. 2 (axial direction of the photosensitive drum 11), and FIG. 3B is a schematic perspective view of the other side. FIG. 4 is a schematic cross-sectional view of the process cartridge 5 in a case where the process cartridge 5 is cut in a direction perpendicular to the axis of the photosensitive drum 11.

In the present embodiment, the process cartridge 5 is coupled to the cleaning unit 10 such that the developing unit 15 is rotatable about a straight line (rotation center 8) connecting fulcrums 8a and 8b. The charging roller 12 provided in the cleaning unit 10 is a contact charging type charging member that abuts on the photosensitive drum 11 and rotates following the photosensitive drum 11. The cleaning blade 13 is an elastic rubber blade, and a tip portion thereof is disposed in contact with the photosensitive drum 11. The cleaning blade 13 serves to remove toner remaining on the photosensitive drum 11. The toner collected by the cleaning blade 13 is stored in a waste toner storage portion 14 in the cleaning unit 10.

The developing unit 15 includes a developing roller 16 as a developing member and a developing blade 17. The developing unit 15 further includes a developing chamber 151 and a developer storage chamber 152. The developing roller 16 is disposed in the developing chamber 151, and the developing blade 17 is disposed with its tip portion in contact with the developing roller 16. The developing blade 17 serves to regulate the toner borne on the peripheral surface of the developing roller 16 to a thin layer. Hereinafter, a direction parallel to the rotation axis of the photosensitive drum 11 or the developing roller 16 is referred to as a longitudinal direction.

The developing unit 15 is biased by a pressure spring 19 (see FIG. 3B) which is an elastic member, and is configured such that the developing roller 16 contacts the photosensitive drum 11 about the rotation center 8. A moment in the R1 direction in FIG. 4 acts on the developing unit 15 by a biasing force of the pressure spring 19. As a result, the developing roller 16 can come into contact with the photosensitive drum 11 at a predetermined pressure. The position of the developing unit 15 with respect to the cleaning unit 10 at this time is defined as a contact position.

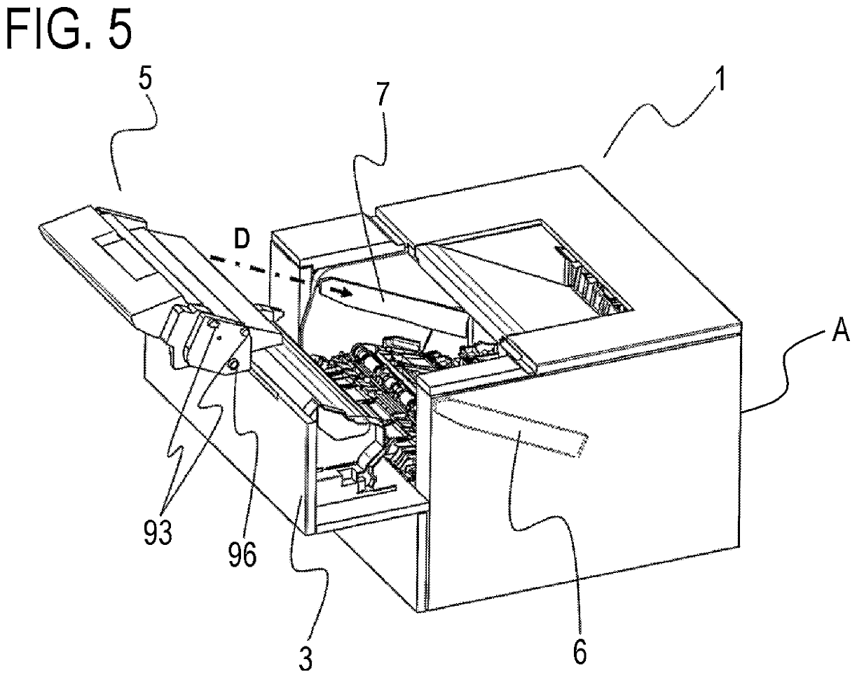

A method of attaching and detaching the process cartridge 5 to and from the printer body A will be described with reference to FIG. 5. FIG. 5 is a schematic perspective view illustrating a state in which the process cartridge is attached to and detached from the image forming apparatus. As illustrated in FIG. 5, a space inside the printer body A serves as a mounting portion of the process cartridge 5. The opening/closing door 3 is rotatably provided with respect to the printer body A, and FIG. 5 illustrates a state in which the opening/closing door 3 is opened. The printer body A includes guide portions 6 and 7. As illustrated in FIG. 3, in the process cartridge 5, an upper boss 93 and a lower boss which are protruding portions protruding in the longitudinal direction are provided on one side surface in the longitudinal direction (left-right direction), and an upper boss 94 and a lower boss 96 are provided on the other side surface. The guide portion 6 is sandwiched with the upper boss 93 and a lower boss 95 and the guide portion 7 is sandwiched with the upper boss 94 and the lower boss 96, so that the process cartridge 5 can be inserted in a direction D of FIG. 5 while being guided by the guide portions 6 and 7. Upon closing the opening/closing door 3 after the process cartridge 5 is inserted, an image can be formed. The process cartridge 5 is removed in the reverse procedure to the above.

### Configuration of Developing Frame Member of Cartridge

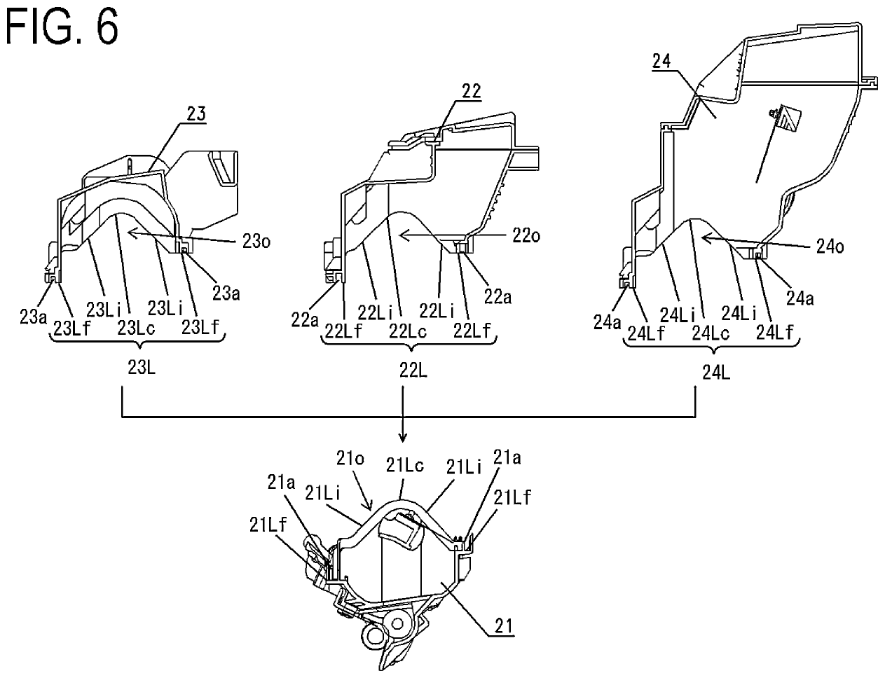

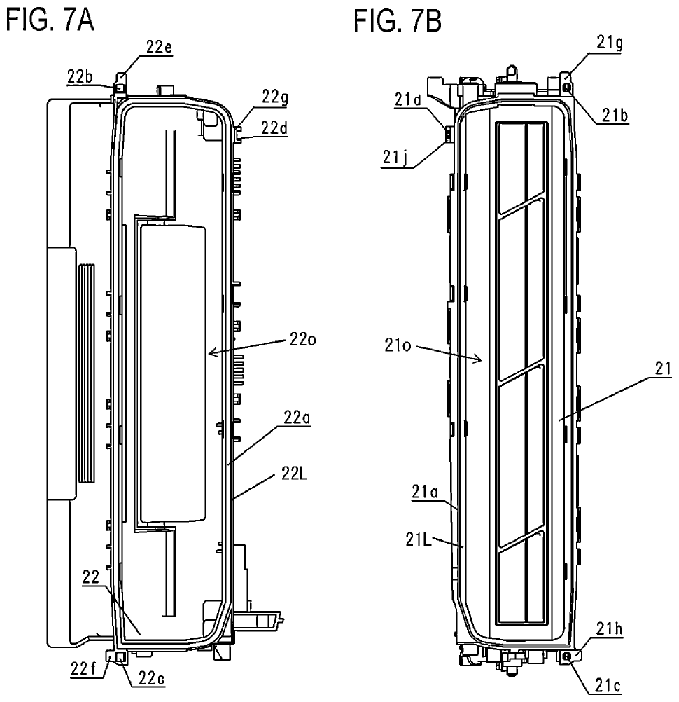

The configuration of the developing frame member configuring the developer storage chamber 152 of the developing unit 15 will be described with reference to FIGS. 4, 6, and 7. FIG. 6 is a cross-sectional view illustrating a divided configuration of a developing cover 22. FIG. 7 is a view illustrating a connection portion between a developer container 21 and the developing cover 22, and is a view as viewed from a facing portion side (a side where each opening portion is opened) of each connection portion.

As illustrated in the drawing, the developing frame member (the container of the developing unit 15) includes the developer container 21 as a resin first frame body that holds the developing roller 16 and the developing blade 17, which are main components, and a developing cover 22 as a resin second frame body that occupies a large frame of the developer storage chamber 152.

An internal space of the developing frame member, particularly, the developer storage chamber (developer storage portion) 152 is formed by connecting an internal space of the developer container 21 and an internal space of the developing cover 22. The developer container 21 has an opening (first opening) 210 that opens its internal space, and similarly, the developing cover 22 has an opening (second opening) 220 that opens its internal space. The opening 210 of the developer container 21 is an opening for communicating the inside of the developer container 21 with the inside of the developing cover 22, and the opening 220 of the developing cover 22 is an opening for communicating the inside of the developing cover 22 with the inside of the developer container 21. That is, the openings 210 and 220 are connected to each other, so that the internal space of the developer container 21 and the internal space of the developing cover 22 communicate with each other.

The developer container 21 and the developing cover 22 are connected to each other by hermetically connecting opening edge portions of the openings 210 and 220. A connection surface 21L (first surface) forming an annular connection line is provided at an opening edge portion of the opening 210 of the developer container 21 so as to surround the opening 210 of the developer container 21. Similarly, a connection surface 22L (second surface) forming an annular connection line is provided at an opening edge portion of the opening 220 of the developing cover 22 so as to surround the opening 220 of the developing cover 22. The connection surface 21L includes a flat surface portion 21Lf extending planarly, an inclined surface portion 21Li extending in a direction inclined with respect to the flat surface portion 21Lf, a curved surface portion 21Lc extending in a curved surface shape, and the like. That is, the connection surface 21L is a connection surface whose height changes in a direction facing the connection surface 22L. Similarly, the connection surface 22L includes a flat surface portion 22Lf extending planarly, an inclined surface portion 22Li extending in a direction inclined with respect to the flat surface portion 22Lf, a curved surface portion 22Lc extending in a curved surface shape, and the like. That is, the connection surface 22L is a connection surface whose height changes in a direction facing the connection surface 21L.

That is, the connection surface 21L of the developing unit 15 in the present embodiment includes the flat surface portion 21Lf and the inclined portions such as the inclined surface portion 21Li and the curved surface portion 21Lc at positions different from the flat surface portion 21Lf in a direction along the opening edge portion of the opening 220. The inclined portion such as the inclined surface portion 21Li and the curved surface portion 21Lc is a shape portion including a portion extending in a direction away from the flat surface portion 21Lf with respect to a direction orthogonal to the flat surface portion 21Lf toward a direction along the opening edge portion of the opening 220. The inclined surface portion 21Li and the curved surface portion 21Lc are examples of such inclined portions. The curved surface portion 21Lc is a portion that forms a curved surface at a position different from the flat surface portion 21Lf in the connection surface 21L in the direction along the opening edge portion of the opening 220. The inclined surface portion 21Li is a portion that forms a planar surface having a different angle from the planar surface formed by the flat surface portion 21Lf at a position different from the flat surface portion 21Lf and the curved surface portion 21Lc in the direction along the opening edge portion of the opening 220.

On the surface of the connection surface 21L of the developer container 21, a rib (protruding portion) 21a is annularly provided along the extending direction of the connection surface 21L so as to protrude from the surface of the connection surface 21L and surround the opening 210. On the surface of the connection surface 22L of the developing cover 22, a groove portion (recessed portion) 22a is provided annularly along the direction in which the connection surface 22L extends so as to be recessed from the surface of the connection surface 22L and surround the opening 220. The annular rib 21a is inserted into the annular groove portion 22a, and a hot melt 43 as a connection member described later seals and connects these gaps, so that an annular connection portion is formed between the developer container 21 and the developing cover 22.

Here, the hot melt in the present embodiment has lower rigidity than the material (for example, ABS, polystyrene, and the like) used for the frame body, and is applied to the developing cover 22 side in a molten state at a high temperature in the assembly step of the cartridge. The Young's modulus as an index of rigidity is 2000 to 3000 MPa for ABS and polystyrene, which are frame materials, whereas the Young's modulus of the hot-melt in this embodiment is about 5 MPa at normal temperature, which is a sufficiently low value. In addition, in a case where the temperature of the cartridge is raised to about 40° C. at the time of using the image forming apparatus, the hot melt is further softened, and the Young's modulus thereof is about ⅕.

As the developing cover, for example, as illustrated in FIG. 6, developing covers 23 and 24 having different volumes of developer storage portion are prepared in addition to the developing cover 22, and are selectively attached to the developer container 21 in accordance with the specifications of the cartridge. Therefore, the shape of the connection portion of the developing covers 22 to 24 with the developer container 21 is the same.

That is, the developing cover 23 has an opening 230 as a second opening configured in the same manner as the opening 220 of the developing cover 22, and has an annular connection surface 23L as a second surface configured in the same manner as the connection surface 22L of the developing cover 22 at an opening edge portion thereof. The connection surface 23L includes a flat surface portion 23Lf configured similarly to the flat surface portion 22Lf of the developing cover 22, an inclined surface portion 23Li configured similarly to the inclined surface portion 22Li of the developing cover 22, a curved surface portion 23Lc configured similarly to the curved surface portion 22Lc of the developing cover 22, and the like.

Similarly, the developing cover 24 has an opening 240 as a second opening configured similarly to the opening 220 of the developing cover 22, and has an annular connection surface 24L as a second surface configured similarly to the connection surface 22L of the developing cover 22 at an opening edge portion thereof. The connection surface 24L includes a flat surface portion 24Lf configured similarly to the flat surface portion 22Lf of the developing cover 22, an inclined surface portion 24Li configured similarly to the inclined surface portion 22Li of the developing cover 22, a curved surface portion 24Lc configured similarly to the curved surface portion 22Lc of the developing cover 22, and the like.

### Configuration of Connection Portion of Developing Frame Member

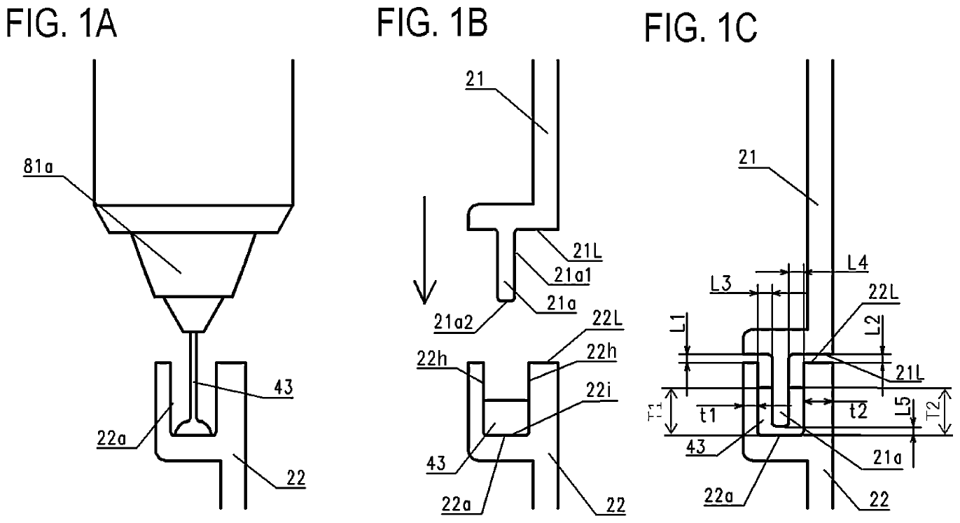

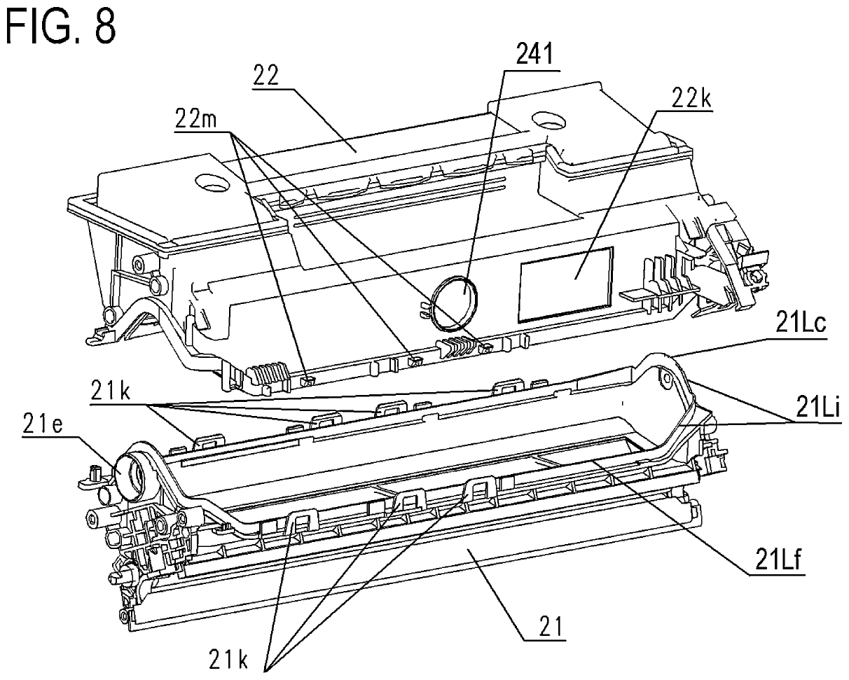

Next, details of the connection portion will be described with reference to FIGS. 1, 7, and 8. FIG. 1 is a schematic cross section illustrating a detailed configuration of a connection portion, and is a view illustrating a step of applying the hot melt 43. FIG. 8 is a perspective view illustrating a divided configuration of the developing frame member.

Here, in the case of preparing a plurality of units having different toner capacities, the frame body of the common portion having the developing blade, the cleaning blade, and the like needs to be made small according to the small capacity. In order to eliminate unnecessary space, it is effective that the connection surface (connection line) between the frame bodies is not a simple joint between flat surfaces (joint line is a combination of straight lines), but a line avoiding various components to be arranged as illustrated in FIG. 8. In a case where such a connection line is formed, it is difficult to adopt ultrasonic welding which is a general joining method. That is, in the ultrasonic welding, it is difficult to complicate the shape of a welding horn and to dispose a space of the receiving portion and the like, and the ultrasonic welding cannot be easily configured, and high accuracy is required for the connection surface even if the ultrasonic welding can be configured. In addition, the larger the difference in toner capacity, the larger the difference in unit size. Therefore, in a configuration in which another component is assembled after the frame body is connected (joined), device cost and labor for a conveyance line, setup, and the like corresponding to different unit sizes occur.

As illustrated in FIG. 1C, a groove portion (recessed portion) 22a for applying the hot melt 43 is provided in the developing cover 22 so as to extend on the connection surface 22L along the extending direction of the connection surface 22L. In the developer container 21, a rib (protruding portion) 21a inserted into the groove portion 22a in a state of being connected to the developing cover 22 is provided on the connection surface 21L so as to extend along the direction in which the connection surface 21L extends. A groove portion (recessed portion) may be provided in the developer container 21, and a rib (protruding portion) may be provided in the developing cover 22. That is, it is sufficient that a rib is provided on one connection surface of the developer container 21 and the developing cover 22, and a recessed portion is provided on the other connection surface.

The state illustrated in FIG. 1C is a state in which the developer container 21 and the developing cover 22 are hermetically connected. In this connection state, a gap is provided between the developer container 21 and the developing cover 22 as indicated by L1 to L5 in the drawing. That is, the connection surface 21L of the developer container 21 and the connection surface 22L of the developing cover 22 face each other with a gap in the joining direction between the developer container 21 and the developing cover 22. More specifically, between the connection surface 21L and the connection surface 22L, a gap of L1 is formed on the frame outer side with respect to a region where the rib 21a and the groove portion 22a are fitted, and a gap of L2 is formed on the frame inner side. Between the rib 21a and the groove portion 22a, a gap of L3 is formed between a side surface 21al of the rib 21a on the frame outer side and a groove side surface 22h of the groove portion 22a on the frame outer side, and a gap of LA is formed between the side surface 21al of the rib 21a on the frame inner side and the groove side surface 22h of the groove portion 22a on the frame inner side. Furthermore, a gap L5 is formed between the tip of the rib 21a and a groove bottom surface 22i of the groove portion 22a. That is, the rib 21a is inserted into the groove portion 22a such that a tip surface 21a2 of the rib 21a and the groove bottom surface 22i of the groove 22a are not in contact with each other with a space therebetween. In order to fill at least a part of these gaps, a hot melt 43 is provided between the rib 21a and the groove portion 22a so as to be in contact with at least both the tip surface 21a2 of the rib 21a and the groove bottom surface 22i of the groove portion 22a.

That is, the developer container 21 and the developing cover 22 are integrated through the hot melt 43 which is a connection member.

Further, as illustrated in FIGS. 7A and 7B, the ribs 21a and the groove portions 22a provided in the developer container 21 and the developing cover 22 are formed over the entire circumference of the annular connection portion, and the connection cross section illustrated in FIG. 1C is also configured over the entire circumference of the connection portion.

In addition, the developer container 21 is provided with a positioning boss 21b (first engagement portion), a positioning boss 21c (second engagement portion), and a fixing rib 21d (third engagement portion) as positioning portions (engagement portions). In addition, the developing cover 22 is provided with a positioning hole 22b (first engaged portion), a rotation stopping hole 22c (second engaged portion), and a fixing portion 22d (third engaged portion) as positioning portions (engaged portions). Although details will be described later, the gaps L1 to L5 illustrated in FIG. 1C are maintained by engagement of those components.

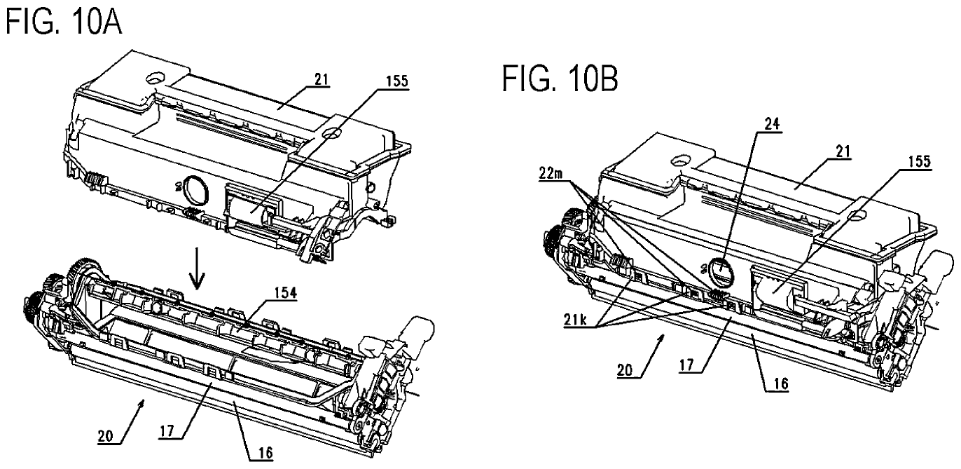

In addition, the connection portion of the unit frame body in the present embodiment is not configured by a combination of simple linear connection surfaces. Specifically, as illustrated in FIGS. 8 and 10A, the three-dimensional connection surface is formed by a combination of slopes and curves avoiding the cylindrical portion 21e which is a support portion of the stirring member 154 disposed in the developer container 21, an attachment hole 22k of the remaining amount detection member 155 attached to the developing cover 22, and the like. That is, the connection surface 21L of the developer container 21 includes a protruding curved surface portion 21Lc and inclined surface portions 21Li on both sides thereof at both longitudinal ends of the developer container 21, and includes a flat surface portion 21Lf extending in the longitudinal direction between both longitudinal ends. The connection surface 22L of the developing cover 22 facing these surfaces includes a recessed curved surface portion 22Lc and inclined surface portions 22Li on both sides thereof at both longitudinal ends, and includes a flat surface portion 22Lf extending in the longitudinal direction between both longitudinal ends (see FIG. 7 and the like). For this reason, in a case where ultrasonic welding, which is a general bonding method, is to be adopted, a device such as complication of a welding horn or multiple horns, a space of a receiving portion, and the like are required, and thus a technical difficulty is high.

### Method for Manufacturing Developing Unit

Hereinafter, a method for manufacturing the developing unit 15 according to the present embodiment will be described in detail together with the positioning configuration of the frame body. Note that many components such as a stirring member, a sealing member, and gears are assembled to the developing unit 15, but here, a method of assembling components related to main portions in the developing unit 15 according to the present embodiment will be described, and the other components will be appropriately omitted.

### First Step: Assembly of Developing Blade (Attachment Step)

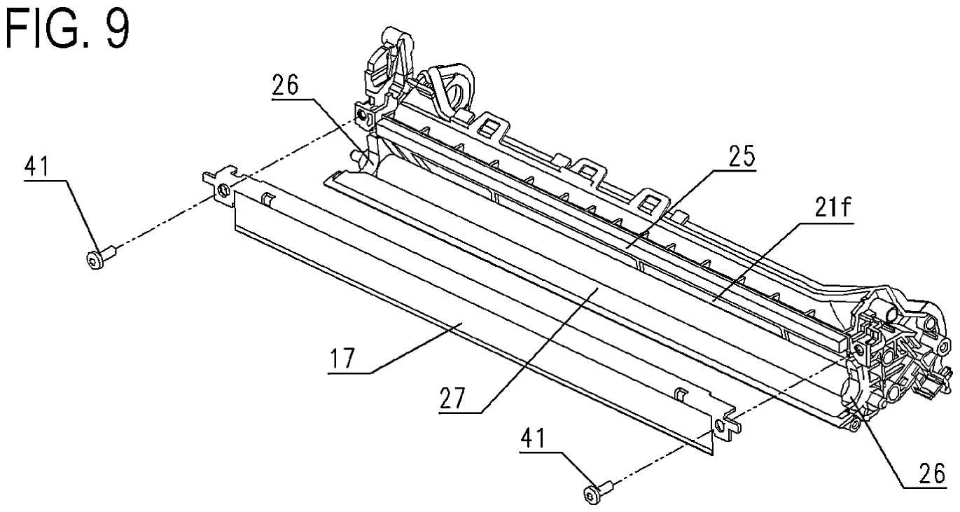

A step of assembling the developing blade (developer regulating member) 17 to the developer container 21 will be described with reference to FIGS. 9 and 10. FIG. 9 is an exploded perspective view illustrating an assembly configuration of the developing blade, and FIG. 10 is an exploded perspective view illustrating a state immediately before a second process to be described later.

First, as illustrated in FIG. 9, a blade back seal 25, an end seal 26, and a blowout prevention member 27, which are sealing members for sealing a periphery of a developing opening 21f of the developer container 21, are attached. Then, the developing blade 17 is assembled as illustrated in the drawing and fixed with a screw 41. In the present embodiment, the developing blade 17 is attached to the developer container 21 before the developing frame member is joined. In general ultrasonic bonding, the developing blade 17 and the blowout prevention member 27 are assembled after the frame body is bonded in order to prevent deterioration of positional accuracy in order to perform bonding while correcting a dimensional error and a warpage influence of the connection portion. Then, the developing roller, gears, and other components are assembled, and most of the components configuring the developing unit 15 are assembled to the developer container 21, resulting in the state of the developing subunit 20 illustrated in FIG. 10.

### Second Step: Coating of Connection Member on Developing Cover (Coating Step, Molten Resin Supply Step)

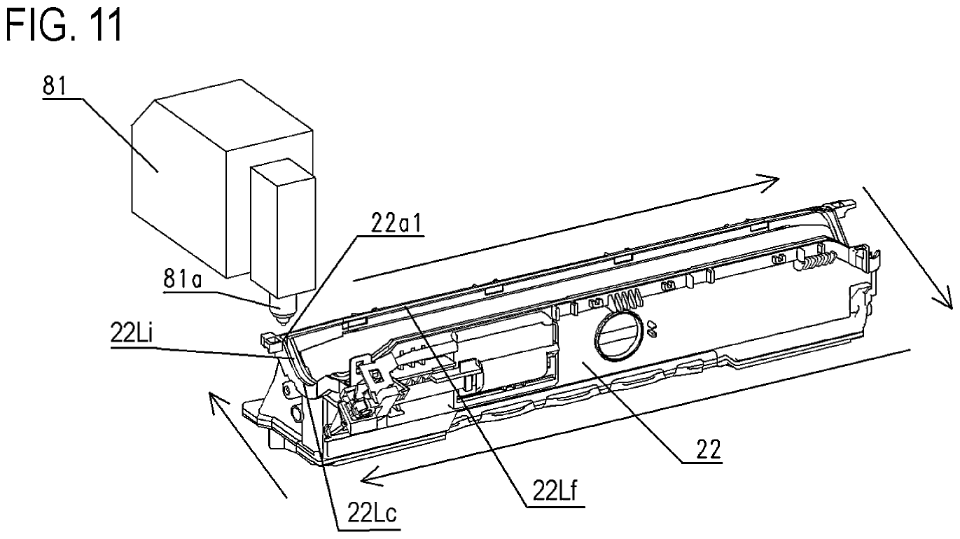

Next, a coating configuration (supply configuration) of the hot melt 43, which is a connection member to the developing cover 22, will be described with reference to FIGS. 1, 7, and 11. FIG. 11 is a perspective view illustrating a coating step.

As described with reference to FIG. 7A, the groove portion 22a is formed in the developing cover 22 over the entire circumference of the opening portion of the frame body in order to apply the hot melt 43 which is a molten resin. Although the entire image of the coating device is not illustrated, a coating nozzle 81a of a coating device 81 is brought close to the groove portion 22a as illustrated in FIG. 1A with respect to the groove portion 22a. Then, the coating nozzle 81a is relatively moved with respect to the groove portion 22a along the extending direction of the annular groove portion 22a with the buffer portion 22al illustrated in FIG. 11 as a starting point, and the hot melt 43 is sequentially applied with one stroke in the arrow direction in the drawing.

Since the buffer portion 22al is coated with the hot melt 43 at the start of coating and at the end of coating in an overlapping manner for sealing the developer, the buffer portion 22al is made deeper than the groove depth illustrated in FIG. 1 to widen a space for accommodating the hot melt 43 in the groove portion 22a. In addition, in the present embodiment, since the connection portion has an inclined portion, coating to the inclined surface is also required, but since the coating amount of the hot melt 43 is an amount that also contacts the groove inner wall, the influence of the sagging flow is small due to the adhesiveness of the hot melt.

Third Step: Connection between Developer Container and Developing Cover (Joining Step)

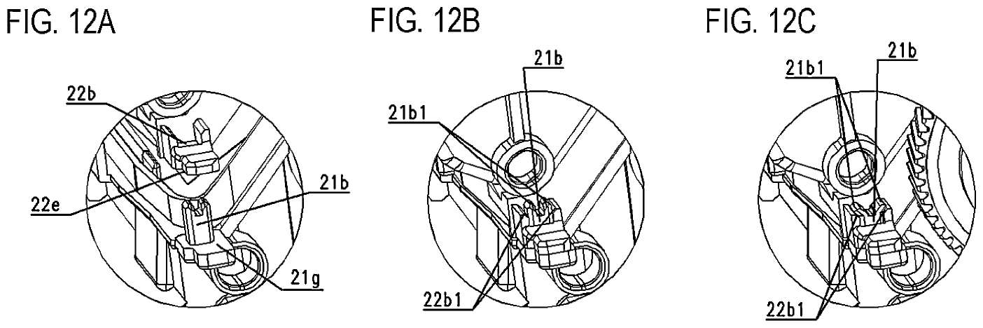

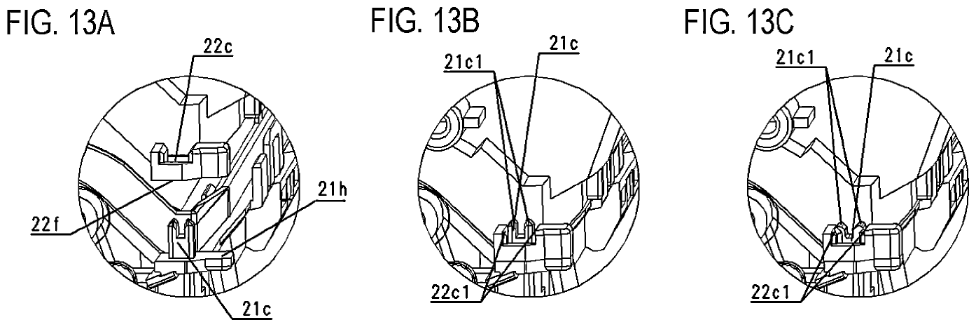

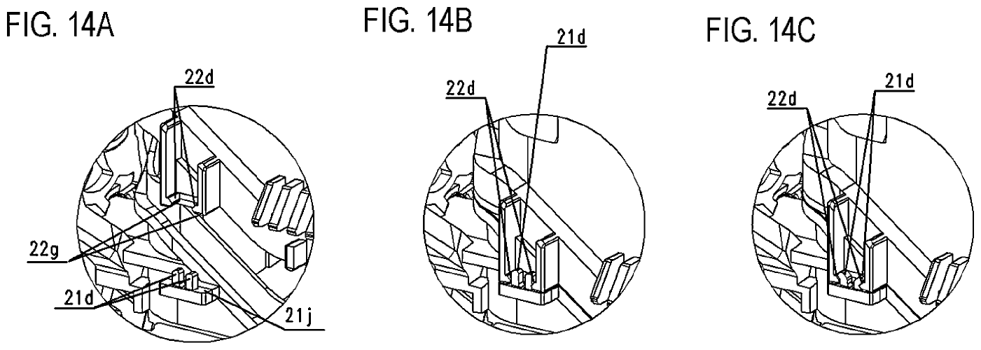

Next, a connection process and a positioning configuration of the developer container 21 and the developing cover 22 will be described with reference to FIGS. 7, 10, 12, 13, and 14. FIG. 12 is an enlarged perspective view of the vicinity of a positioning boss 21b and a positioning hole 22b which are positioning portions of the developer container 21 and the developing cover 22. FIG. 13 is an enlarged perspective view of the vicinity of a positioning boss 21c and a rotation stopping hole 22c which are positioning portions of the developer container 21 and the developing cover 22. FIG. 14 is an enlarged perspective view of the vicinity of a fixing rib 21d and a fixing portion 22d which are fixing portions between the developer container 21 and the developing cover 22.

The developing cover 22 to which the hot melt 43 is applied is assembled to the developing subunit 20 as illustrated in FIG. 10A while the hot melt 43 is in the molten state, and becomes the state illustrated in FIG. 10B. With this assembly, the rib 21a is inserted into the groove portion 22a such that at least the tip portion of the rib 21a is immersed in the molten hot melt 43.

As illustrated in FIG. 7B, the developer container 21 is provided with a first abutting surface 21g, a second abutting surface 21h, and a third abutting surface 21j to be first abutting portions (first abutting surfaces). On the other hand, as illustrated in FIG. 7A, the developing cover 22 is provided with a first abutting surface 22e, a second abutting surface 22f, and a third abutting surface 22g to be second abutting portions (second abutting surfaces) at positions facing the abutting surfaces. These abutting surfaces configure a positioning portion with respect to an assembling direction (an arrow direction in FIG. 1B) in the developer container 21 and the developing cover 22. That is, the first abutting surface 21g and the first abutting surface 22e abut on each other, the second abutting surface 21h and the second abutting surface 22f abut on each other, and the third abutting surface 21j and the third abutting surface 22g abut on each other, whereby a relative position of the developer container 21 and the developing cover 22 in the assembling direction is regulated. Each abutting surface is provided outside the connection surface with respect to the internal space of the frame body, that is, outside the connection surfaces 21L and 22L in a direction from the inside to the outside of the frame body storage portion.

In addition, the developer container 21 is provided with a first positioning boss 21b and a second positioning boss 21c for regulating the position in the longitudinal direction (direction parallel to the central axis of the photosensitive drum 11). On the other hand, in the developing cover 22, a positioning hole 22b is provided at a position facing the first positioning boss 21b, and a rotation stopping hole 22c is provided at a position facing the second positioning boss 21c. The first positioning boss 21b and the second positioning boss 21c are configured to be fitted to each other with no gap (with an extremely small gap) as much as possible in the longitudinal direction, and serve as a base point of positioning in the longitudinal direction. On the other hand, the second positioning boss 21c and the rotation stopping hole 22c are configured to be fitted to each other with a gap having a larger margin than first positioning boss 21b and second positioning boss 21c in the longitudinal direction. The first positioning boss 21b and the positioning hole 22b are fitted (the state of FIGS. 12A to 12B), and the second positioning boss 21c and the rotation stopping hole 22c are fitted (the state of FIGS. 13A to 13B), whereby the position in the longitudinal direction is restricted. As described above, the developing cover 22 is positioned with respect to the developer container 21, and at this time, the connection portion is changed from the state illustrated in FIG. 1B to the connection state illustrated in FIG. 1C. Therefore, a state in which the developer container 21 and the developing cover 22 are connected through the hot melt 43 illustrated in FIG. 1C over the entire circumference of the connection portion is maintained.

That is, the joining step includes a moving step of relatively moving at least one of the developer container 21 and the developing cover 22 with respect to the other such that the tip portion of the rib 21a is immersed in the molten hot melt 43. In addition, this moving step includes a positioning step of positioning the developer container 21 and the developing cover 22 with respect to each other.

### Fourth Step: Fixing of Developer Container and Developing Cover (Engaging Step)

Next, a method of fixing the developer container 21 and the developing cover 22 will be described with reference to FIGS. 12, 13, and 14. The fixing portion is provided at the same position as the three abutting surfaces (in the vicinity of each abutting surface). First, fixing of the positions of the first abutting surfaces 21g and 22e will be described.

As illustrated in FIG. 12B, the positioning boss 21b of the developer container 21 is provided with a first caulking portion 21b1 serving as a fixing portion (engagement portion). On the other hand, a first engaged portion 22b1 is provided at an edge of the positioning hole 22b of the developing cover 22. In the state of FIG. 12B, the first caulking portion 21b1 is heated by a heating unit (not illustrated) and deformed until being engaged with the first engaged portion 22b1 (FIG. 12C). As a result, the deformed first caulking portion 21b1 serves as a retainer, and in particular, the first abutting surfaces 21g and 22e arranged in the vicinity thereof are fixed so as to be restricted from being separated from each other. That is, the first abutting surface 21g (first abutting surface) and the first abutting surface 22e (second abutting surface) are restricted from relatively moving in the direction intersecting the first abutting surface 21g or the first abutting surface 22e by the retaining function of the first caulking portion 21b1.

Similarly, in the second abutting surfaces 21h and 22f, as illustrated in FIGS. 13B and 13C, the second caulking portion 21cl provided in the second positioning boss 21c is heated and deformed to be engaged with the second engaged portion 22cl provided at the edge of the rotation stopping hole 22c. As a result, the deformed second caulking portion 21cl serves as a retainer, and the second abutting surfaces 21h and 22f are fixed so as to be restricted from being separated from each other. That is, the second abutting surface 21h (first abutting surface) and the second abutting surface 22f (second abutting surface) are restricted from relatively moving in the direction intersecting the second abutting surface 21h or the second abutting surface 22f by the retaining function of the second caulking portion 21c1.

Next, fixing of the third abutting surfaces 21j and 22g will be described. As illustrated in FIG. 14A, a fixing rib 21d as an engagement portion is provided on the third abutting surface 21j on the developer container 21 side, and a fixing portion 22d as an engaged portion is provided on the third abutting surface 22g of the developing cover 22. Here, in a case where the third abutting surfaces 21j and 22g abut on each other, the fixing rib 21d and the fixing portion 22d have a gap in the longitudinal direction, and thus are not involved in regulation in the longitudinal direction. Subsequently, the fixing rib 21d is heated and deformed to engage with the fixing portion 22d, so that the fixing for restricting the third abutting surfaces 21j and 22g arranged in the vicinity thereof from being separated from each other is completed. Thereafter, the remaining parts, in the present embodiment, the bearing member 90 illustrated in FIG. 3A are assembled.

### Description of Retainer Snap-Fit

Here, in the present embodiment, three fixing portions are provided, but since the fixing portions are also used for positioning, the fixing portions are arranged at ends in the longitudinal direction. For example, in a case where the temperature rises during transportation of the cartridge, or in a case where transportation by air or transportation in high ground occurs, a load is applied in a direction in which the connection between the developer container 21 and the developing cover 22 is released due to an increase in the internal pressure of the developer storage chamber 152 sealed for the purpose of preventing leakage of the developer. At this time, the frame body may be deformed at the central portion in the longitudinal direction away from the fixing portion, and the connection may be disconnected. In the present embodiment, as illustrated in FIG. 8, a snap-fit shape portion 21k for retaining as an engagement portion is provided on the developer container 21 side, and a third engaged portion 22m is provided on the developing cover 22 side. In the connection state between the developer container 21 and the developing cover 22, the snap-fit shape portion 21k and the third engaged portion 22m are engaged with each other to prevent detachment of the connection portion in a case where an internal pressure in the developer storage chamber 152 increases.

Through the engagement step described above, the developer container 21 and the developing cover 22 are positioned and fixed to each other, and the hot melt 43 is cooled and cured (curing step), whereby the developer container 21 and the developing cover 22 are integrated, and the frame body of the developing unit 15 is completed.

### Fifth Step: Developer Filling in Developing Unit (Filling Step)

Finally, a predetermined amount of developer is filled from a filling port 241 which is a hole portion for filling developer provided in the developing cover 22, and sealed with a cap member (not illustrated), whereby the developing unit 15 is in a completed state.

As described above, in the present embodiment, since the connection member can be applied to the connection portion between the frame bodies with one stroke, for example, the connection surface (connection line) can be set while avoiding components to be assembled to the developer container 21. That is, according to the present embodiment, the degree of freedom in designing the joining lines of the unit frame body is improved. Accordingly, since a complicated connection surface can be formed, it is possible to prepare a cartridge having a smaller capacity, which contributes to miniaturization of the cartridge. In addition, since the hot melt 43 is applied not to the side of the developer container 21 to which most components are assembled but to the side of the developing cover 22, the coating device 81 does not interfere with other components at the time of coating. In the case of such a complicated joining line, it is difficult to perform joining by ultrasonic welding as an alternative means due to a split multi-horn welding horn, a space of a receiving portion, and the like.

In addition, after most of the components are assembled to the developer container 21, the connection step of the frame member (the developing cover 22 in the present embodiment) that determines the size of the developing unit 15 is performed in the latter half of the assembly order, so that it is possible to increase the common part of the manufacturing line. As a result, it is possible to reduce the device supercost and the trouble of changing the set-up in manufacturing the cartridges having different capacities on the same manufacturing line.

In addition, as illustrated in FIG. 1C, a gap is provided between the groove portion 22a formed in the developing cover 22 and the rib 21a formed in the developer container 21, and the hot melt 43 is in a molten state at the time of coating, so that it is possible to absorb component tolerance and warpage influence. As a result, the connection portions do not interfere even in the step of connecting the frame members to each other, and the load applied to the developer container 21 is small, so that the influence on the positional accuracy of the developing blade 17 and the blowout prevention member 27 can be reduced.

Furthermore, the hot melt 43 has a property of softening at a high temperature. In the present embodiment, hot melt is selected so as to have rigidity of about ⅕ in a state where the temperature of the cartridge is raised when used in the image forming apparatus. As a result, even if the deformation between the frame bodies is different due to a thermal expansion difference at the time of temperature rise due to the shape difference between the developer container 21 and the developing cover 22, the deformation can be absorbed by a gap between the connection portions and the softened connection member therebetween, and it is possible to reduce the influence on the positional accuracy of the component and achieve the sealing property.

In addition, in a case where the connection surface between the frames has an inclined surface, the coating amount of the groove portion 22a of the hot melt 43 is an amount of contact with three surfaces of the inner wall (the bottom surface 22i and both side surfaces 22h (FIG. 1C) of the groove portion 22a). As a result, it is possible to apply the hot melt 43 in a uniform amount over the entire circumference where the influence of the sagging flow is small due to the viscosity of the hot melt 43 which is a hot melt.

In the present embodiment, both the developer container 21 and the developing cover 22 are configured to have the recessed frame body meter having the opening portion, but the present invention is also applicable to a configuration in which one of them is a frame body having a flat shape such as a lid and closes the other opening portion.

### Second Embodiment

A configuration and a manufacturing method of a cleaning unit according to a second embodiment of the present invention will be described. Note that the overall configuration of the image forming apparatus main body and the cartridge in the second embodiment is similar to that in the first embodiment, and thus the description thereof will be omitted. Here, points different from the first embodiment in the second embodiment will be described, and description of points common to the first embodiment in the second embodiment will be omitted.

### Configuration of Cleaning Frame Body

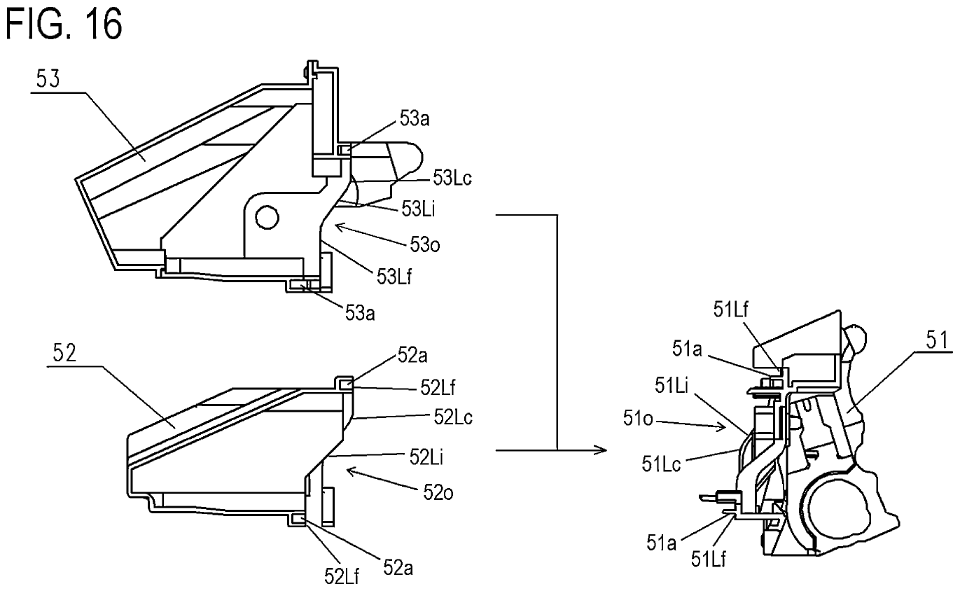

A cleaning frame configuring a waste toner storage portion 14 of a cleaning unit 10 will be described with reference to FIGS. 4 and 16. FIG. 16 is a diagram illustrating an example of a divided configuration of the cleaning frame body.

As illustrated in FIG. 4, the cleaning unit 10 includes a photosensitive drum 11 as a main component, a charging roller 12, and a cleaning blade 13 as a cleaning member. The cleaning frame body includes a cleaning container 51 as a first frame body that holds these main components, and a cleaning cover 52 as a second frame body that occupies a large frame of the waste toner storage portion 14. A hot melt 44 as a connection member to be described later is arranged over the entire circumference of the connection portion between the cleaning container 51 and the cleaning cover 52.

Here, similarly to the first embodiment, also in the present embodiment, the hot melt has low rigidity as compared with the material (for example, ABS, polystyrene, and the like) used for the frame body, and is applied to the cleaning cover 52 side in a molten state at a high temperature in the assembly step of the cartridge.

As the cleaning cover, for example, as illustrated in FIG. 16, a cleaning cover 53 having a different volume of the waste toner storage portion 14 is prepared, and is selectively attached to the cleaning container 51 according to the specification of the cartridge. Therefore, the shapes of the connection portions of the cleaning covers 52 and 53 are the same.

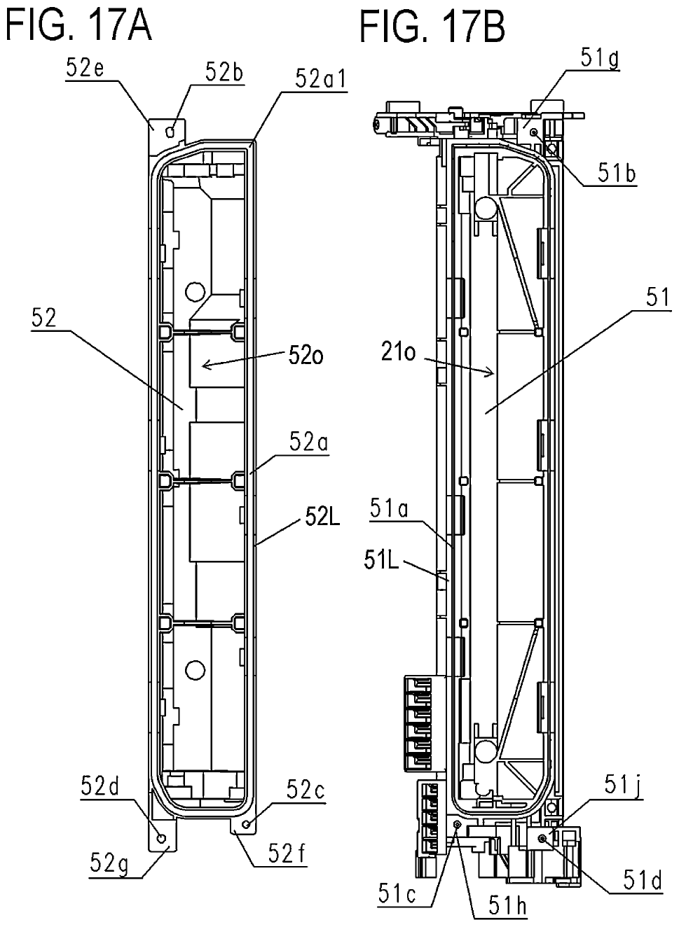

That is, the cleaning container 51 has the opening 510 as a first opening (opening portion), and has an annular connection surface 51L (FIG. 17B) as the first surface at the opening edge portion. The connection surface 51L includes a flat surface portion 51Lf, an inclined surface portion 51Li, a curved surface portion 51Lc, and the like.

In addition, the cleaning cover 52 is a frame body that is connected to the cleaning container 51 so as to cover the opening 510 of the cleaning container 51 and forms a storage portion for storing the developer together with the cleaning container 51. The cleaning cover 52 has an opening 520 as a second opening, and has an annular connection surface 52L (FIG. 17A) as a second surface at an opening edge portion thereof. The connection surface 52L is a connection surface extending along the direction in which the connection surface 51L extends while facing the connection surface 51L, and includes a flat surface portion 52Lf, an inclined surface portion 52Li, a curved surface portion 52Lc, and the like.

Similarly, the cleaning cover 53 has an opening 530 as a second opening configured similarly to the opening 520 of the cleaning cover 52, and has an annular connection surface 53L as a second surface configured similarly to the connection surface 52L of the cleaning cover 52 at an opening edge portion thereof. The connection surface 53L includes a flat surface portion 53Lf configured similarly to the flat surface portion 52Lf of the cleaning cover 52, an inclined surface portion 53Li configured similarly to the inclined surface portion 52Li of the cleaning cover 52, a curved surface portion 53Lc configured similarly to the curved surface portion 52Lc of the cleaning cover 52, and the like.

### Configuration of Connection Portion of Cleaning Frame Body

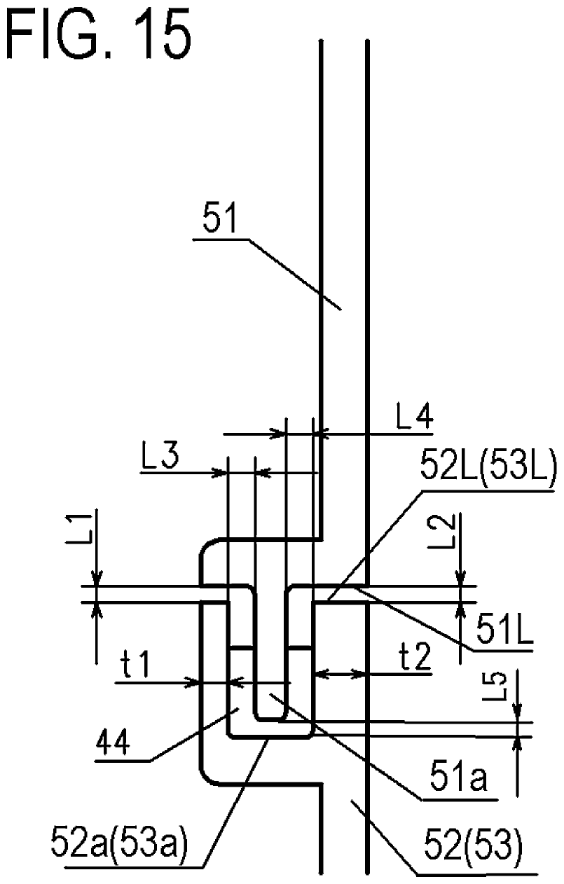

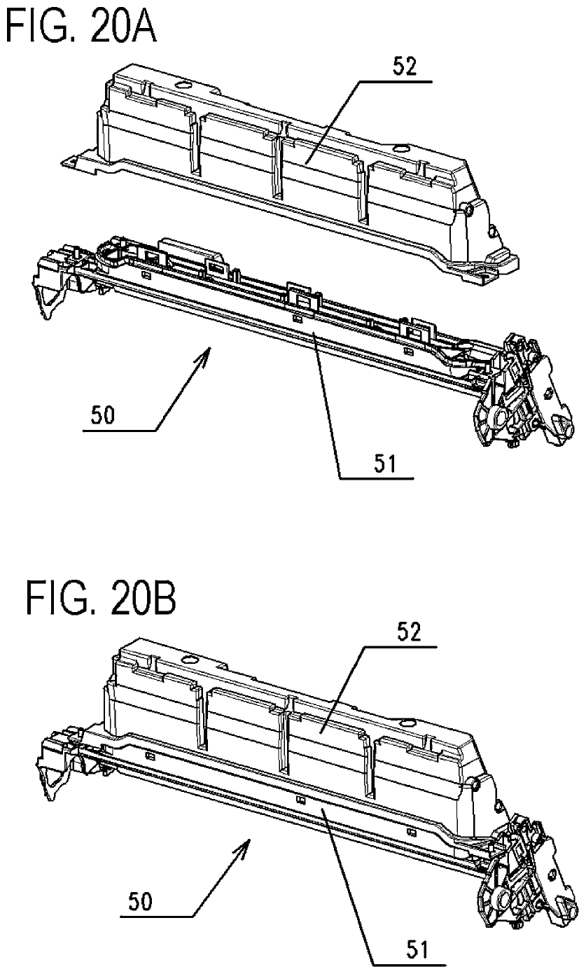

Details of the connection portion will be described with reference to FIGS. 15, 17, and 20. FIG. 15 is a schematic cross section illustrating a detailed configuration of a connection portion in the second embodiment. FIG. 17 is a diagram illustrating a connection portion between the cleaning container 51 and the cleaning cover 52, and is a view of each connection portion as viewed from an opposing portion side. FIG. 20 is a perspective view illustrating a divided configuration of the cleaning frame body.

As illustrated in FIG. 15, the connection portion in the present embodiment includes a rib 51a of the cleaning container 51, a groove portion 52a of the cleaning cover 52, and a connection member 44 (FIG. 15) disposed in a gap between the rib 51a and the groove portion 52a. As illustrated in FIG. 17B, the rib 51a is annularly formed on an annular connection surface 51L surrounding the opening 510 of the cleaning container 51. As illustrated in FIG. 17A, the groove portion 52a is annularly formed on an annular connection surface 52L surrounding the opening 520 of the cleaning cover 52. The cleaning container 51 and the cleaning cover 52 are integrally connected through the hot melt 44, but the details of the cross-sectional configuration are similar to the configuration described with reference to FIG. 1 in the first embodiment, and thus the description thereof is omitted.

### Method for Manufacturing Cleaning Unit

Hereinafter, the method for manufacturing the cleaning unit 10 in the present embodiment will be described in detail together with the positioning configuration of the frame body. Note that, here, a method of assembling components according to a main part in the cleaning unit 10 of the present embodiment will be described, and other components will be omitted as appropriate.

### First Step: Assembly of Cleaning Blade (Attachment Step)

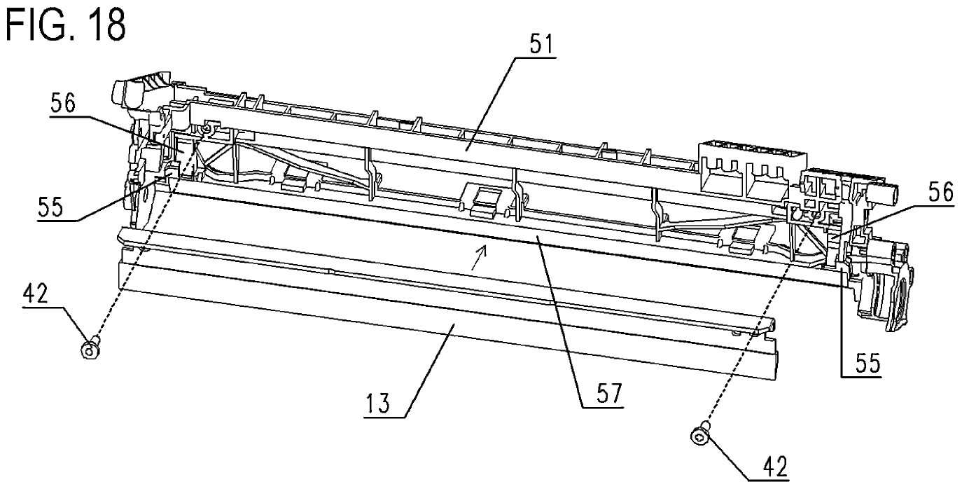

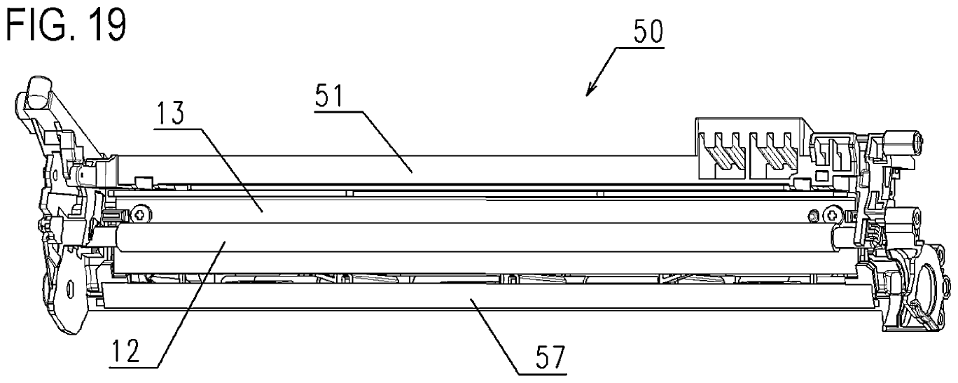

A step of assembling the cleaning blade 13 as a cleaning member to the cleaning container 51 will be described with reference to FIGS. 18 and 19. FIG. 18 is an exploded perspective view illustrating an assembly configuration of the cleaning blade 13, and FIG. 19 is an exploded perspective view illustrating a state of the cleaning subunit 50 immediately before a second step to be described later.

First, as illustrated in FIG. 18, an end seal 55, an end auxiliary seal 56, and a sheet member 57, which are sealing members for sealing the periphery of the opening portion of the cleaning container 51, are attached. Then, the cleaning blade 13 is assembled as illustrated in the drawing and fixed with screws 42. In the present embodiment, the cleaning blade 13 is attached to the cleaning container 51 prior to the connection of the cleaning frame body. In general joining by ultrasonic welding, the cleaning blade 13 and the sheet member 57 are assembled after the frame body is joined in order to prevent deterioration of positional accuracy since the joining is performed while correcting a dimensional error and a warpage influence of the connection portion. Then, the charging roller 12 and other parts are assembled to the cleaning container 51, and the state of the cleaning subunit 50 illustrated in FIG. 19 is obtained.

### Second Process: Coating of Connection Member to Cleaning Cover (Coating Process)

Next, a configuration of applying the hot melt 44 to the cleaning cover 52 will be described with reference to FIGS. 11 and 17.

As illustrated in FIG. 17A, a groove portion 52a is formed in the cleaning cover 52 over the entire circumference of the opening portion of the frame body in order to apply the hot melt 44 which is a molten resin. Although not illustrated because it is similar to the configuration described with reference to FIG. 11 in the first embodiment, the connection member 44 is applied to the groove portion 52a with one stroke starting from the buffer portion 52a1.

Third Step: Connection between Cleaning Container and Cleaning Cover (Joining Step)

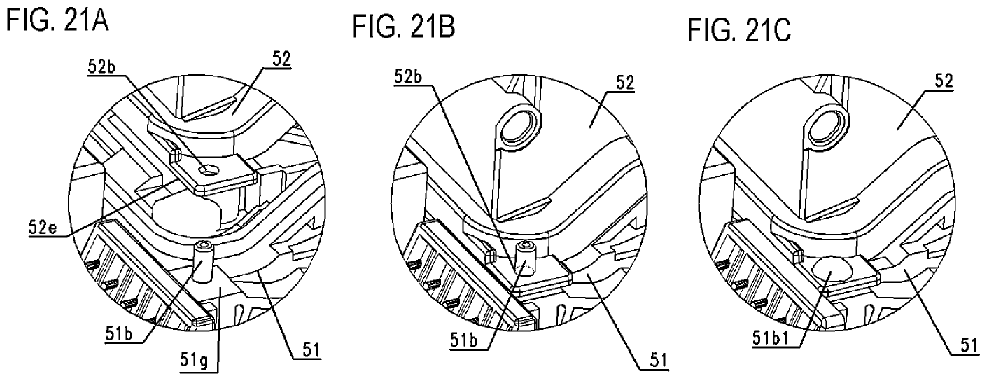

Next, a connection step and a positioning configuration of the cleaning container 51 and the cleaning cover 52 will be described with reference to FIGS. 17, 20, and 21. FIG. 21 is an enlarged perspective view of the vicinity of a positioning portion and a fixing portion of the cleaning container 51 and the cleaning cover 52.

The cleaning cover 52 to which the hot melt 44 is applied is assembled to the cleaning subunit 50 as illustrated in FIG. 20A while the hot melt 43 is in a molten state, and becomes a state illustrated in FIG. 20B. With this assembly, the rib 51a is inserted into the groove portion 52a such that at least the tip portion of the rib 51a is immersed in the molten hot melt 44.

As illustrated in FIG. 17B, the cleaning container 51 is provided with a first abutting surface 51g, a second abutting surface 51h, and a third abutting surface 51j which are first abutting portions. On the other hand, as illustrated in FIG. 17A, the cleaning cover 52 is provided with a first abutting surface 52e, a second abutting surface 52f, and a third abutting surface 52g, which are second abutting portions, at positions facing the abutting surfaces. These abutting surfaces configure a positioning portion with respect to the assembling direction (the same direction as an arrow direction in FIG. 1B) of the cleaning container 51 and the cleaning cover 52. That is, the first abutting surface 51g and the first abutting surface 52e abut on each other, the second abutting surface 51h and the second abutting surface 52f abut on each other, and the third abutting surface 51j and the third abutting surface 52g abut on each other, whereby a relative position of the cleaning container 51 and the cleaning cover 52 in the assembling direction is regulated.

In addition, the cleaning container 51 is provided with a first positioning boss 51b and a second positioning boss 51c for regulating the position in the longitudinal direction (direction parallel to the central axis of the photosensitive drum 11). Further, the cleaning container 51 is provided with a third positioning boss 51d at a position on the same side as the second positioning boss 51c in the longitudinal direction and different from the second positioning boss 51c in the lateral direction orthogonal to the longitudinal direction. On the other hand, in the cleaning cover 52, a positioning hole (long round hole long in the longitudinal direction) 52b is provided at a position facing the first positioning boss 51b, a rotation stopping hole 52c is provided at a position facing the second positioning boss 51c, and a positioning hole (long round hole long in the lateral direction) 52d is provided at a position corresponding to the third positioning boss 51d. The first positioning boss 51b and the positioning hole 52b are fitted to each other, the second positioning boss 51c and the rotation stopping hole 52c are fitted to each other, and the third positioning boss 51d and the positioning hole 52d are fitted to each other, whereby the position in the longitudinal direction is restricted. As described above, the cleaning cover 52 is positioned with respect to the cleaning container 51, and at this time, the connection portion is in the connection state illustrated in FIG. 15.

### Fourth Step: Fixing (Engaging Step) of Cleaning Container and Cleaning Cover

Next, a method of fixing the cleaning container 51 and the cleaning cover 52 will be described with reference to FIG. 21. The fixing portion is provided at the same location as the above-described three abutting surfaces. In the present embodiment, since the fixing methods of the three fixing portions are the same, only one of the fixing portions of the first positioning boss 51b and the positioning hole 52b will be described.

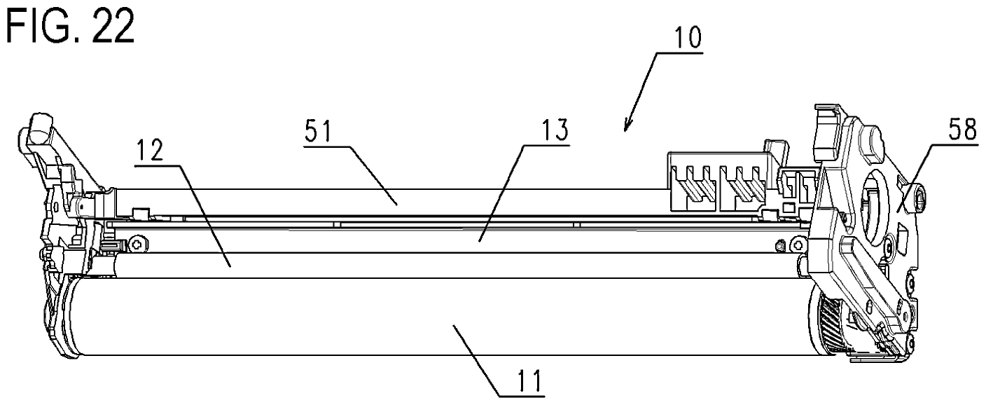

As illustrated in FIGS. 21A and 21B, the first positioning boss 51b of the cleaning container 51 is fitted to the positioning hole 52b of the cleaning cover 52, and the abutting surface 51g and the abutting surface 52e abut on each other. Next, the positioning boss 51b is heated and deformed by a heating unit (not illustrated) from a state illustrated in FIG. 21B to be in a state illustrated in FIG. 21C. As a result, the tip portion 51b1 of the deformed first positioning boss 51b serves as a retainer, the cleaning container 51 and the cleaning cover 52 are fixed, and the cleaning cover 52 and the cleaning subunit 50 are held in a state of FIG. 20B. Thereafter, the remaining parts such as the photosensitive drum 11 and the bearing member 58 are assembled, whereby the cleaning unit 10 is completed (FIG. 22).

As described above, also, in the present embodiment, the hot melt 44 is applied not to the cleaning container 51 side to which most components are assembled but to the cleaning cover 52 side, so that the coating device 81 does not interfere with other components at the time of applying the hot melt 44.

As illustrated in FIG. 15, similarly to the developing unit 15 illustrated in FIG. 1C, a predetermined gap is provided between the groove portion 52a formed in the cleaning cover 52 and the rib 51a formed in the cleaning container 51. Furthermore, since the hot melt 44 is in a molten state at the time of coating, component tolerance and warpage influence can be absorbed. Accordingly, the connection portions do not interfere with each other even in the step of connecting the frame bodies to each other, and a load applied to the cleaning container 51 is small, so that it is possible to reduce the influence on the positional accuracy of the cleaning blade 13 and the sheet member 57.

Furthermore, the hot melt 44 has a property of softening at a high temperature. As a result, as in the first embodiment, even if the deformation between the frame bodies is different due to the thermal expansion difference at the time of temperature rise due to the shape difference between the cleaning container 51 and the cleaning cover 52, the deformation can be absorbed by the gap between the connection portions and the softened connection member therebetween, and it is possible to reduce the influence on the positional accuracy of the component and achieve the sealing performance.

In addition, a step of connecting the frame body (the cleaning cover 52 in the present embodiment) that determines the size of the cleaning unit 10 after the main components such as the cleaning blade are assembled to the cleaning container 51 is adopted, and thus, it is possible to increase the common portion of the manufacturing line. As a result, it is possible to reduce the device supercost and the trouble of changing the set-up when the cartridges having different capacities are manufactured on the same manufacturing line.

### Third Embodiment

A configuration and a manufacturing method of a toner cartridge C according to a third embodiment of the present invention will be described. Here, points different from the first and second embodiments in the third embodiment will be described, and description of points common to the first and second embodiments in the third embodiment will be omitted.

The toner cartridge C illustrated in FIG. 2 supplies the developer to a developing unit 15 through a path (not illustrated), and collects the collected toner collected by a cleaning unit 10 through a path (not illustrated).

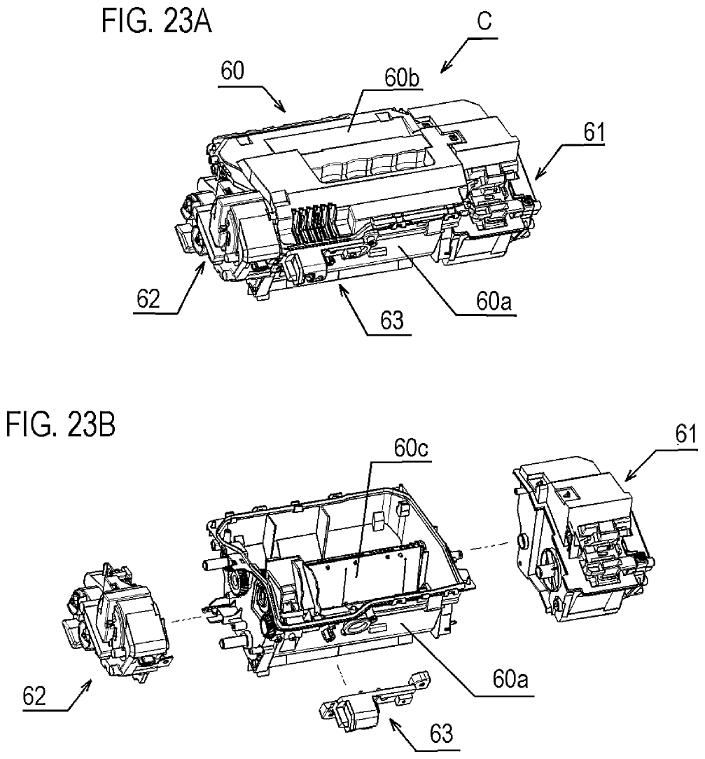

As illustrated in FIG. 23A, the toner cartridge C includes a toner frame 60 having a developer storage chamber, a waste toner frame 61 that stores collected toner, a gear unit 62 that drives a stirring member disposed in the toner frame 60, and a shutter unit 63 that opens and closes an opening portion for supplying developer from the toner frame 60. As illustrated in FIG. 23B, in the toner frame 60, a stirring member 60c is disposed, and the waste toner frame 61, the gear unit 62, and the shutter unit 63 are fixed.

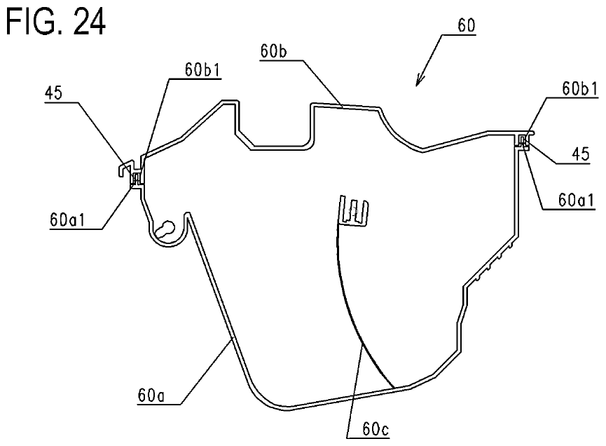

As illustrated in FIG. 24, the toner frame 60 includes a toner container 60a and a toner cover 60b, and is integrally formed with a hot melt 45 interposed therebetween. Then, a rib 60al as a connection portion is formed on the toner container 60a side to which the component is assembled, and a groove portion 60b1 for applying the hot melt 45, which is the hot melt material 45, is formed on the toner cover 60b side over the entire circumference of the connection portion. A rib (protruding portion) 60al is provided on an annular connection surface (first surface) formed on an opening edge portion of an opening (first opening) of the toner container (first frame body) 60a. The groove portion (recessed portion) 60b1 is provided on a connection surface (second surface) formed at an opening edge of an opening (second opening) of the toner cover (second frame body) 60b. Similarly to the connection surfaces of the first and second embodiments, each connection surface includes a flat surface portion, an inclined surface portion, and a curved surface portion. Here, a plurality of toner covers having different sizes are prepared (not illustrated).

By configuring the toner cartridge C as described above, the toner cover 60b to which the hot melt 45 is applied can be assembled after each unit and component are assembled.

As described above, a frame body (the toner cover in the present embodiment) that determines the size of the toner cartridge C can be connected after the components are assembled to the toner container 60a, so that it is possible to increase the common parts of the manufacturing line. This makes it possible to reduce the device extra cost and the trouble of changing the set-up in manufacturing the toner cartridges having different capacities on the same manufacturing line.

Note that the cross-sectional configuration, the fixing method, and the like of the connection portion between the toner container 60a and the toner cover 60b are similar to the configurations described in the first and second embodiments, and thus the description thereof will be omitted.

In particular, in the order of the manufacturing step in the present embodiment, before the molten resin supply step, the developing blade 17 requiring high attachment position accuracy is first assembled to the developer container 21 as the first frame body. Thereafter, the developing cover 22, which is the second frame body, is attached to the developer container 21 using the hot melt 43.

In this case, for example, in a case where the developing cover 22 and the developer container 21 are assembled while being restrained in the longitudinal direction, there is a case where the developer container 21 follows the thermally expanded developing cover 22 due to the heat of the hot melt 43, and the attachment position of the developing blade 17 is affected. Therefore, in the present manufacturing step order, it is necessary to consider to reduce the positional fluctuation of the developing blade 17 due to the heat of the hot melt 43 at the time of assembly. Specifically, in the present configuration, it is preferable that the influence of the thermal expansion of the developing cover 22 due to the heat of the hot melt 43 is not given to the developer container 21 as much as possible.

In order to solve these problems, a method for locking the developer container and the developing cover will be described in detail below.

### Fourth Embodiment

A configuration and a manufacturing method of a developing unit 15b according to a fourth embodiment of the present invention will be described. Here, differences from the first to third embodiments will be mainly described in the fourth embodiment, and description of common points with the first to third embodiments in the fourth embodiment may be omitted.

### Connection Between Developer Container and Developing Cover (Locking by Heating Deformation)

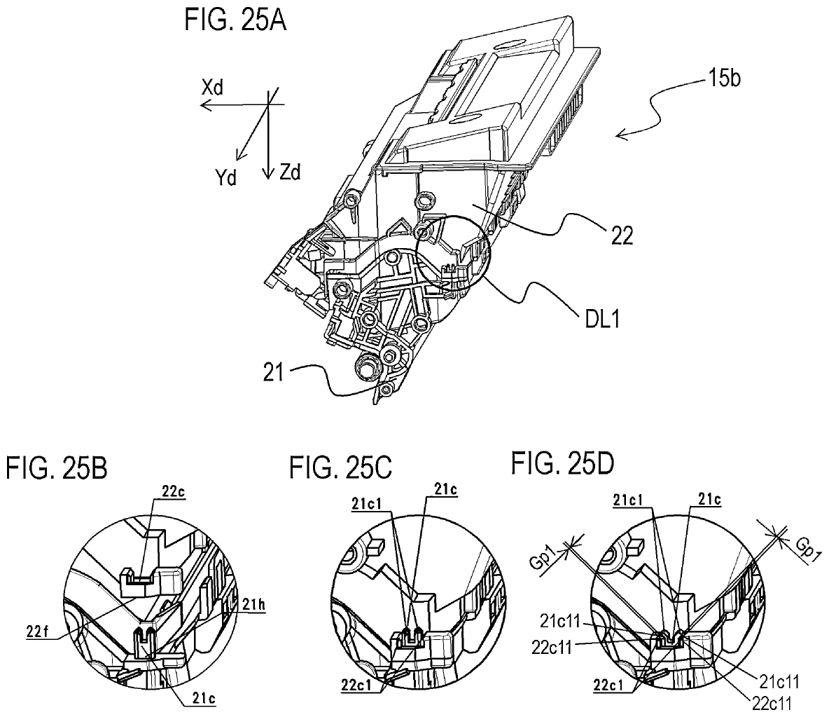

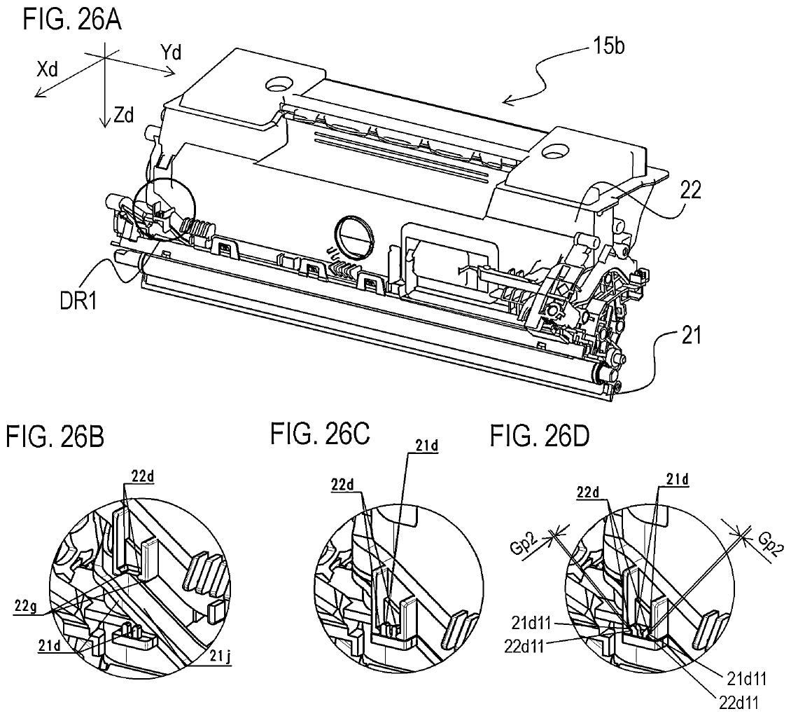

As another embodiment of the developing cover locking method, details of a locking unit by heating deformation will be described with reference to FIGS. 25 and 26. FIG. 25A is a perspective view of the developing unit 15b. FIGS. 25B to 25D are enlarged views of a DL1 portion in FIG. 25A. FIG. 25B illustrates a state before the developing cover 22 and the developer container 21 are connected. FIG. 25C illustrates a state in which the second positioning boss 21c and the rotation stopping hole 22c are fitted to each other. FIG. 25D illustrates a state after the second positioning boss 21c is heated and deformed. FIG. 26A is a perspective view of the developing unit 15b. FIGS. 26B to 26D are enlarged views of the DL1 portion in FIG. 26A. FIG. 26B illustrates a state before the developing cover 22 and the developer container 21 are connected. FIG. 26C illustrates a state in which the fixing rib 21d and the fixing portion 22d are fitted. FIG. 26D illustrates a state after the fixing rib 21d is heated and deformed.

Similarly to the developing unit 15 of the first embodiment, the second positioning boss 21c is provided in the developer container 21 in the developing unit 15b of this embodiment. The arrangement of the second positioning bosses 21c in the developer container 21 is on the second abutting surface 21h provided on the developer container 21 similarly to the developing unit 15 of the first embodiment (that is, as illustrated in FIG. 7B and the like). Similarly to the developing unit 15 of the first embodiment, the second abutting surface 21h is provided outside the connection surface with respect to an internal space of the frame body of the developing unit 15b, that is, outside the connection surfaces 21L and 22L in the direction from the inside to the outside of the frame body storage portion. As in the first embodiment, the connection surface 22L of the developing cover 22 of the developing unit 15b is provided with a groove portion (recessed portion) 22a to which the hot melt 43 is applied. The connection surface 21L of the developer container 21 of the developing unit 15b is provided with a rib (protruding portion) 21a to be inserted into the groove portion 22a in a state where the developer container 21 is connected to the developing cover 22.

Similarly to the developing unit 15 in the first embodiment, the rotation stopping hole 22c is provided in the developing cover 22 of the developing unit 15b in this embodiment. The arrangement of the rotation stopping hole 22c in the developing cover 22 is a second abutting surface 22f provided on the developing cover 22, and is a position facing the second positioning boss 21c of the developer container 21, similarly to the developing unit 15 of the first embodiment (that is, as illustrated in FIG. 7A and the like). Similarly to the developing unit 15 of the first embodiment, the second abutting surface 22f is provided outside the connection surface with respect to the internal space of the frame body of the developing unit 15b, that is, outside the connection surfaces 21L and 22L in the direction from the inside to the outside of the frame body storage portion.

Similarly to the developing unit 15 of the first embodiment, the second positioning boss 21c is provided together with the first positioning boss 21b to regulate the position of the developer container 21 with respect to the developing cover 22 in the longitudinal direction (direction parallel to the central axis of the photosensitive drum 11). Similarly to the developing unit 15 in the first embodiment, the second positioning boss 21c and the rotation stopping hole 22c form a retaining portion by heating and deforming the caulking portion 21cl on a side opposite to the engagement portion (retaining portion) between the first positioning boss 21b and the positioning hole 22b in the longitudinal direction of the developing unit 15b. That is, the rotation stopping hole 22c is engaged with the caulking portion 21cl of the second positioning boss 21c, and thus, functions to regulate a relative rotation (the second abutting surfaces 21h and 22f are spaced apart from each other) between the developer container 21 and the developing cover 22 with the engagement portion between the first positioning boss 21b on the opposite side in the longitudinal direction of the developing unit 15b and the positioning hole 22b as a base point.

Similarly to the developing unit 15 of the first embodiment, the fixing rib 21d is provided in the developer container 21 in the developing unit 15b of this embodiment. The arrangement of the fixing rib 21d in the developer container 21 is on a third abutting surface 21j provided in the developer container 21, similarly to the developing unit 15 of the first embodiment (that is, as illustrated in FIG. 7B and the like). As illustrated in FIG. 7B and the like, a third abutting surface 21j (fixing rib 21d) is provided on the same side as the side on which the first abutting surface 21g is provided and on the opposite side to the side on which the second abutting surface 21h (second positioning boss 21c) is provided in the longitudinal direction of the developing unit 15b.

Similarly to the developing unit 15 of the first embodiment, the fixing portion 22d is provided on the developing cover 22 in the developing unit 15b of this embodiment. Similarly to the developing unit 15 of the first embodiment (that is, as illustrated in FIG. 7A and the like), the fixing portion 22d of the developing cover 22 is disposed at a position that is a third abutting surface 22g provided on the developing cover 22 and faces the fixing rib 21d of the developer container 21.

Hereinafter, in the developing unit 15b of the present embodiment, differences from other embodiments will be mainly described.

At the time of heating deformation of the caulking portion 21cl illustrated in FIG. 25, a heating condition is set so as to have a slight gap Gp between the second positioning boss 21c and the rotation stopping hole 22c (as a coupling means such that the developer container 21 and the developing cover 22 contact each other).

In FIGS. 25 and 26, the joining direction (third direction) between the developer container 21 and the developing cover 22 is defined as a Zd direction. The joining direction (third direction) is also a direction intersecting (orthogonal to) the first abutting surface 21g, the second abutting surface 21h, and the third abutting surface 21j as the first abutting surfaces. A longitudinal direction (second direction) of the developing unit orthogonal to the joining direction is defined as a Yd direction, and a direction (first direction) orthogonal (intersecting) to both the joining direction and the longitudinal direction is defined as an Xd direction. The longitudinal direction (second direction) of the developing unit is also a direction along the first abutting surface 21g, the second abutting surface 21h, and the third abutting surface 21j as the first abutting surfaces. Note that this coordinate system (Xd, Yd, Zd) is merely for convenience of description of the configuration of the developing unit of the present embodiment, and does not necessarily correspond to a coordinate system (Xc, Yc, Zc) used for description of a cleaning unit of another embodiment to be described later. However, the Yd direction and the Yc direction are parallel to each other in a state where the developing unit and the cleaning unit are attached to the main body of the image forming apparatus.

After the heating deformation, the pair of caulking portions 21cl spreads so that their tips are separated from each other in a direction (Xd direction) orthogonal to (intersecting) each of the joining direction (Zd direction) of the developer container 21 and the developing cover 22 and the developing unit longitudinal direction (Yd direction). A distance between the tips of the pair of caulking portions 21cl after the heating deformation is larger than a width of the rotation stopping hole 22c in the Xd direction (a distance between the pair of second engaged portions 22cl in the Xd direction). As a result, when the developer container 21 and the developing cover 22 attempt to be separated from each other in the joining direction, the tip sides of the pair of caulking portions 21cl are caught by the pair of second engaged portions 22cl of the rotation stopping hole 22c. Accordingly, separation between the developer container 21 and the developing cover 22 is restricted.

Here, the pair of caulking portions 21cl has a slight gap Gp1 between the pair of second engaged portions 22cl in a state where the developer container 21 and the developing cover 22 are joined. More specifically, each of the pair of caulking portions 21cl has an opposing surface 21c11 as a restriction surface, and each of the pair of second engaged portions 22cl has an opposing surface 22c11 as a restricted surface. The facing surface 21c11 and the facing surface 22c11 are surfaces along the longitudinal direction as the second direction and along the Xd direction orthogonal to the longitudinal direction and the direction inclined with respect to each of the Xd direction and the Zd direction orthogonal to the longitudinal direction. The facing surface 21c11 and the facing surface 22c11 face each other in a direction orthogonal to the inclination direction to form a gap Gp1.

Since the gap Gp1 is provided, the positioning boss 21c and the rotation stopping hole 22c melt with each other at the time of heating deformation and are not completely fixed (integrated). In the present embodiment, the gap Gp1 is provided to about 0.1 to 1.5 mm.

Since the first positioning boss 21b and the positioning hole 22b are fitted to each other with as little gap as possible in the longitudinal direction (second direction), relative movement is restricted. That is, the surface of the first positioning boss 21b facing the positioning hole 22b in the longitudinal direction serves as the restriction surface, and the surface of the positioning hole 22b facing the first positioning boss 21b in the longitudinal direction serves as the surface to be restricted, so that the relative movement between the first positioning boss 21b and the positioning hole 22b in the longitudinal direction is restricted. On the other hand, the second positioning boss 21c and the rotation stopping hole 22c are configured to be fitted to each other with a gap therebetween in the longitudinal direction (second direction), and are configured to allow relative movement within a predetermined range in the longitudinal direction (a second direction). Furthermore, in the present embodiment, due to the gap Gp1, the second positioning boss 21c and the rotation stopping hole 22c are loosely fitted to allow relative movement within a predetermined range in a direction (direction including a first direction and a third direction) orthogonal to (intersecting with) the longitudinal direction (second direction).

On the other hand, as illustrated in FIG. 26, the fixing rib 21d and the fixing portion 22d are also configured such that a gap Gp2 is provided after the heating deformation similarly to the second positioning boss 21c and the rotation stopping hole 22c. However, unlike the gap Gp1, the gap Gp2 is a gap that allows relative movement of the fixing rib 21d and the fixing portion 22d in a predetermined range in the longitudinal direction (second direction).

Tips of the pair of fixing ribs 21d are expanded so as to be separated from each other in the Yd direction which is the longitudinal direction of the toner cartridge C by heating deformation. A distance between the tips of the pair of fixing ribs 21d after the heating deformation is wider than a distance between the pair of fixing portions 22d in the longitudinal direction. Accordingly, in a case where the developer container 21 and the developing cover 22 are separated from each other in the joining direction, the tip sides of the pair of fixing ribs 21d are caught by the pair of fixing portions 22d. Accordingly, separation between the developer container 21 and the developing cover 22 is restricted.

Here, the pair of fixing ribs 21d has the slight gap Gp2 between the pair of fixing portions 22d in a state where the developer container 21 and the developing cover 22 are joined. More specifically, each of the pair of fixing ribs 21d has an opposing surface 21d11 as a restriction surface, and each of the pair of fixing portions 22d has an opposing surface 22d11 as a surface to be restricted. The facing surface 21d11 and the facing surface 22d11 are surfaces along the Xd direction orthogonal to the longitudinal direction and along directions inclined with respect to the longitudinal direction and the Zd direction orthogonal to the longitudinal direction, respectively. The facing surface 21d11 and the facing surface 22d11 face each other in a direction orthogonal to the inclination direction to form a gap Gp2.

Furthermore, as illustrated in FIG. 26, the fixing portion 22d is a rectangular hole in the longitudinal direction, and has a U shape in which one end side in an Xd direction orthogonal (intersecting) to the longitudinal direction (Yd direction) is released.

With the gap Gp2 and the above-described square hole configuration, the fixing rib 21d and the fixing portion 22d are loosely fitted so as to allow a relative movement within a predetermined range in each of the longitudinal direction and the direction orthogonal to (intersecting) the longitudinal direction.

With the above configuration, the second positioning boss 21c serving as an engaging unit is relatively movable in the longitudinal direction and in the direction orthogonal to the longitudinal direction in the rotation stopping hole 22c. Similarly, the fixing rib 21d and the fixing portion 22d are relatively movable in the longitudinal direction and the direction orthogonal to the longitudinal direction. On the other hand, the first positioning boss 21b and the positioning hole 22b are configured such that the relative movement is restricted with respect to each of the longitudinal direction and the direction orthogonal to the longitudinal direction as in the first embodiment. As a result, the relative movement of the developer container 21 and the developing cover 22 within a predetermined range is allowed, and a dimensional difference can be absorbed by the heat of the hot melt 43 without the developer container 21 following the thermally expanded developing cover 22. Therefore, the developer container 21 and the developing cover 22 can be stably assembled without affecting the attachment position of the developing blade 17.

In the present embodiment, similarly to the first embodiment and the like, with respect to the first positioning boss 21b and the positioning hole 22b arranged on one end side in the longitudinal direction (Yd direction) of the developing unit, the engagement portion by the positioning boss 21c and the rotation stopping hole 22c is arranged on the other end side in the longitudinal direction (Yd direction) of the developing unit. Similarly to the first embodiment and the like, the engagement portion between the fixing rib 21d and the fixing portion 22d is disposed closer to one end side in the longitudinal direction (Yd direction) of the developing unit between the first positioning boss 21b and the positioning hole 22b and the engagement portion between the second positioning boss 21c and the rotation stopping hole 22c. Similarly to the first embodiment (see FIG. 7), each engagement portion is arranged in the vicinity of a corner portion between a line extending in the longitudinal direction and a line extending in a direction intersecting the longitudinal direction among connection lines of the developer container 21 and the developing cover 22. Such an arrangement is merely an example, and may be more suitable according to the configuration of the frame body, the shape of the opening edge portion, and the like.

Even in a case where the gaps Gp1 and Gp2 are 0, the above-described relative movement between the developer container 21 and the developing cover 22 is possible in a state where the gaps Gp1 and Gp2 are not completely fixed and integrated, for example, when a poly washer (not illustrated) or the like is disposed in the gaps Gp1 and Gp2 and a pressing force F in the cross-sectional direction is small. Accordingly, even if the developing cover 22 thermally expands, the developing cover is not restrained in the longitudinal direction with respect to the developer container 21, and the object is achieved.

That is, the predetermined range in the relative movement between the developer container 21 and the developing cover 22 allowed by the gaps Gp1 and Gp2 can be said to be a range in which the above target can be achieved while ensuring the sealing property and the integration therebetween.

In a case where a heating temperature is too high even with the gaps Gp1 and Gp2, the positioning boss 21c and the rotation stopping hole 22c may be compatible with each other and integrated. In such a case, the production conditions such as lowering the heating temperature of a heating tool and lowering a pressing pressure may be changed, and both the above components may be appropriately selected so as not to be compatible with each other.

As another embodiment, in addition to the caulking by heating as described above, a method of crushing and locking the boss tip by pressure without applying heat may be adopted.

### Fifth Embodiment

A configuration and a manufacturing method of a developing unit 15c according to a fifth embodiment of the present invention will be described. Here, points different from the first to fourth embodiments in the fifth embodiment will be described, and description of points common to the first to fourth embodiments in the fifth embodiment will be omitted.

Connection between Developer Container and Developing Cover (Locking by Snap-Fit Claw)

The developing unit 15c according to the present embodiment is different from the developing units according to the other embodiments in the configurations of the positioning portions (the engagement portion and the engaged portion) of the developer container 21 and the developing cover 22. Specifically, instead of the engagement configuration including the positioning boss 21c and the rotation stopping hole 22c in another embodiment, the present embodiment includes a first engagement configuration using a positioning boss 221c (second engagement portion) and a positioning hole 222c (second engaged portion), and a second engagement configuration using a snap-fit claw 221p (fourth engagement portion) and a positioning hole 222q (fourth engaged portion). These two engagement configurations are configured to regulate two directions intersecting the longitudinal direction while allowing relative movement in a predetermined range in the longitudinal direction of the developer container 21 and the developing cover 22.

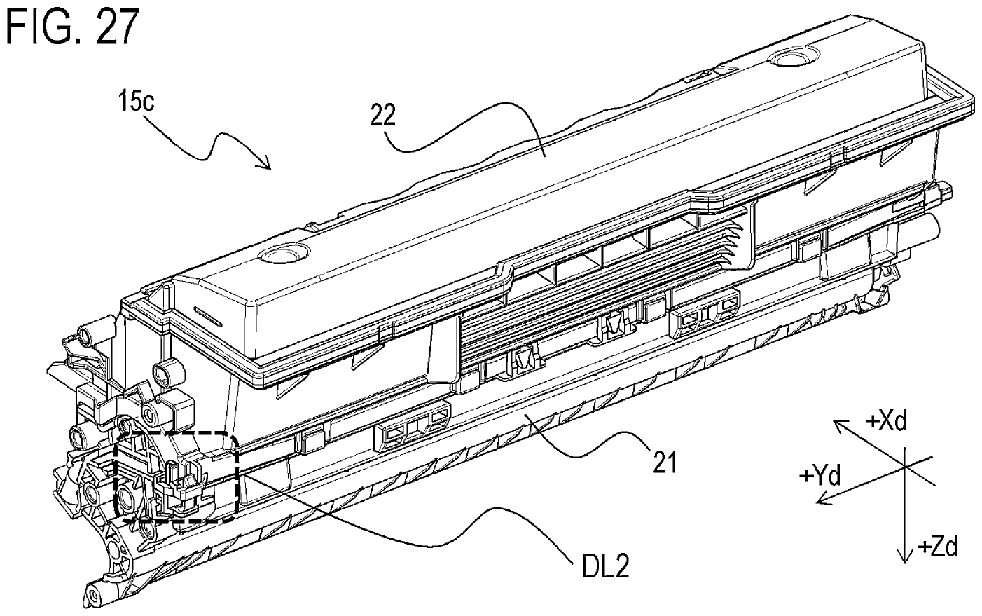

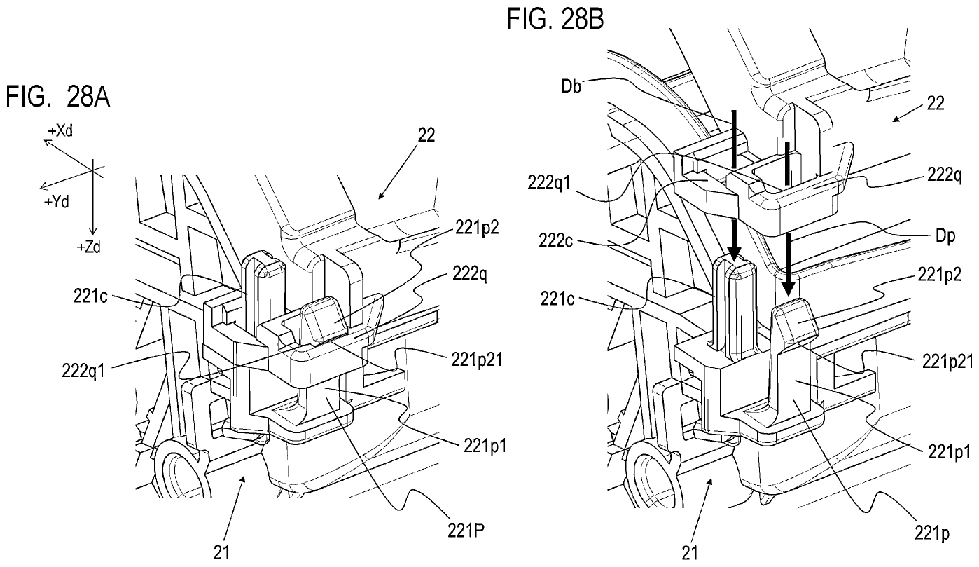

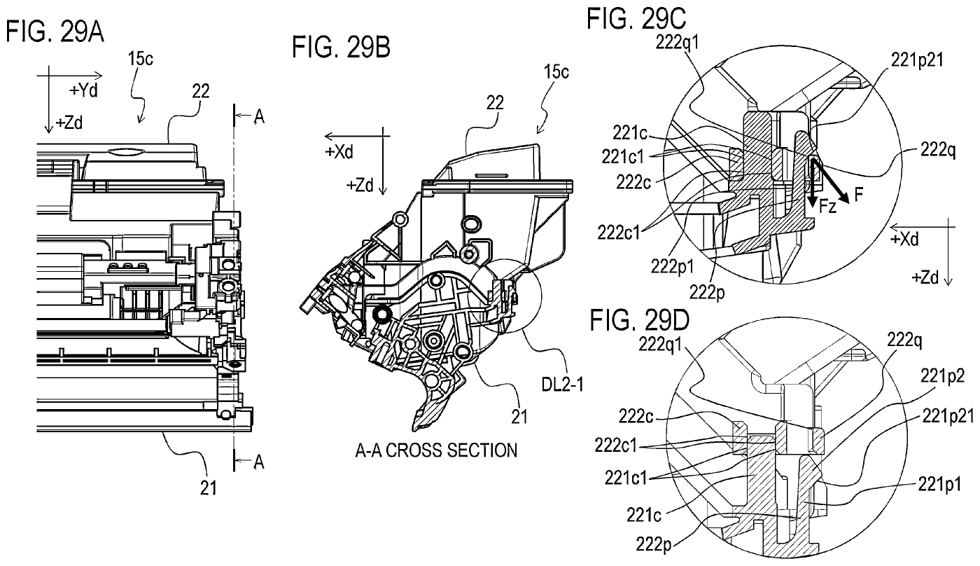

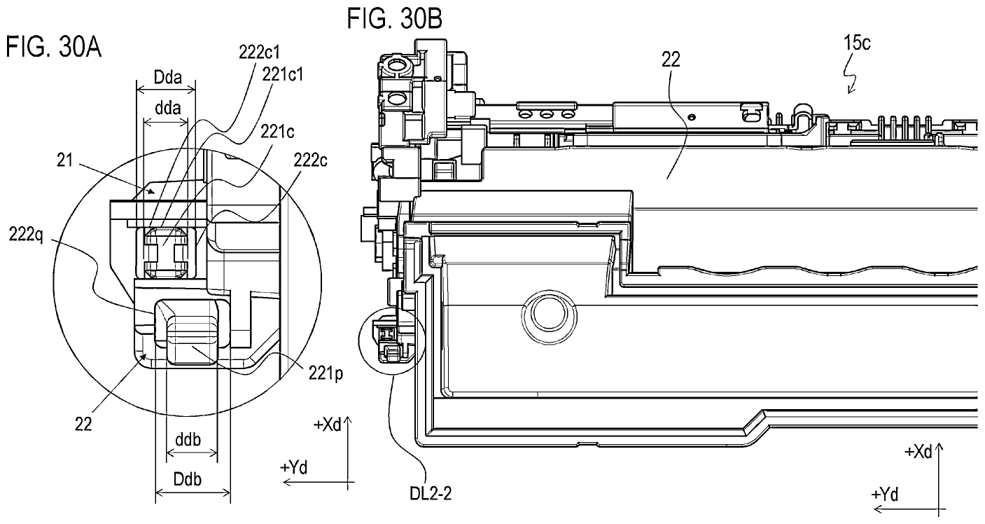

Details of the locking means in the present embodiment will be described with reference to FIGS. 27, 28, 29, and 30. FIG. 27 is an external perspective view of the developing unit 15c in the fifth embodiment, FIG. 28 is an enlarged view of a DL2 portion of FIG. 27, and FIG. 29 is a diagram illustrating a locking configuration by a snap-fit claw on one end side of the developing unit. FIG. 29A is a view of one longitudinal end side of the developing unit as viewed in a direction orthogonal to the longitudinal direction, and FIG. 29B is a cross-sectional view (a cross-sectional view taken along arrow A) of one longitudinal end side of the developing unit as viewed in the longitudinal direction (−Yd direction). FIG. 29C is an enlarged view of a DL2-1 portion of FIG. 29B, and is a detailed diagram illustrating the force of the snap-fit claw 221p. FIG. 29D is an enlarged view of the DL2-1 portion of FIG. 29B, and is a detailed view illustrating a state in the middle of a coupling step between the developer container 21 and the developing cover 22 and illustrating a state immediately before the snap-fit claw 221p is bent. FIG. 30A is an enlarged view of a DL2-2 part of FIG. 30B, and is an enlarged view of the DL2 part of FIG. 27 as viewed from above. FIG. 30B is a view in which one longitudinal end side of the developing unit is viewed in a direction orthogonal to the longitudinal direction and different from that in FIG. 29A.

As illustrated in FIG. 28, a positioning boss 221c as a second engagement portion is provided in the developer container 21 as the first frame body, and a positioning hole 222c as a second engaged portion is provided in the developing cover 22 as the second frame body. The positioning boss 221c is a protruding portion extending toward the developing cover 22 along the joining direction (Zd direction) between the developer container 21 and the developing cover 22. The positioning hole 222c is a hole penetrating in the joining direction, and is configured such that the positioning boss 221c is inserted in the joining direction. The positioning boss 221c has a restriction surface 221cl facing the positioning hole 222c in an Xd direction (first direction) orthogonal (intersecting) to each of the joining direction and the longitudinal direction, and the positioning hole 222c has a restricted surface 222cl facing the restriction surface 221cl in the Xd direction. The restriction surface 221cl and the restricted surface 222cl contact each other in the Xd direction and the positioning boss 221c and the positioning hole 222c are engaged with each other, so that a relative movement between the developer container 21 and the developing cover 22 in the Xd direction is restricted at least on one end side in the longitudinal direction.

The developer container 21 is provided with a snap-fit claw 221p as a fourth engagement portion, and the developing cover 22 is provided with a positioning hole 222q as a fourth engaged portion. When the snap-fit claw 221p is engaged with the positioning hole 222q, a relative movement (movement in the separating direction) of the developer container 21 and the developing cover 22 in the Zd direction which is the joining direction of the developer container 21 and the developing cover 22 is restricted at least on one end side in the longitudinal direction.

In addition, the snap-fit claw 221p is configured to generate a force for maintaining a state in which the developer container 21 and the developing cover 22 contact each other as a coupling unit for contacting (abutting) the developer container 21 in the joining direction with the developing cover 22.

In the developer container 21, the positioning boss 221c and the snap-fit claw 221p are provided at positions close to each other. Similarly, in the developing cover 22, the positioning hole 222c and the positioning hole 222q are provided at positions close to each other.

As illustrated in FIG. 29, the snap-fit claw 221p is provided with an inclined surface 221p21 as an engaging force applying portion, and is locked to a ridgeline 222q1 as an engaging force receiving portion of the positioning hole 222q. The snap-fit claw 221p includes an arm portion 221p1 extending toward the developing cover 22 side along the joining direction of the developer container 21 and the developing cover 22, and a claw portion 221p2 protruding in a direction (−Xd direction) intersecting the joining direction on the tip side of the arm portion 221p1. The claw portion 221p2 is provided with an inclined surface 221p21. The positioning hole 222q is a hole penetrating in the joining direction, and is configured such that the snap-fit claw 221p is inserted in the joining direction. The ridgeline 222q1 is provided at the edge of the opening portion on the downstream side in the insertion direction of the snap-fit claw 221p in the opening portion of the positioning hole 222q.

A claw portion 221p2 of the snap-fit claw 221p protrudes from the opening portion of the positioning hole 222q so as to protrude in a direction intersecting the insertion direction of the snap-fit claw 221p (the joining direction of the developer container 21 and the developing cover 22). The snap-fit claw 221p has flexibility in the arrow +Xd direction, and causes elastic deformation in which the snap-fit claw 221p bends in the +Xd direction in the step of joining the developer container 21 and the developing cover 22 (FIG. 29D to FIG. 29C). As a result, the claw portion 221p2 enters the positioning hole 222q, passes through the positioning hole 222q, and can reach a position where the inclined surface 221p21 is in contact with a ridgeline 22q1. That is, the snap-fit claw 221p is brought into a state of being engaged with the positioning hole 222q through an elastic deformation state in the step of joining the developer container 21 and the developing cover 22. As a result, the developer container 21 and the developing cover 22 are locked to each other.

Here, the inclined surface 221p21 of the snap-fit claw 221p is an inclined surface having an angle with respect to a surface parallel to the flexible direction of the snap-fit claw 221p. Therefore, a component force Fz of the force F generated by the reaction force of the bending of the snap-fit claw 221p due to the contact of the positioning hole 222q with the ridgeline 22q1 is received, and acts in the direction in which the developing cover 22 and the developer container 21 are drawn to each other (the arrow +Zd direction which is the joining direction). This is to prevent the position of the developer container 21 and the developing cover 22 from floating in an arrow (−Zd direction) opposite to the joining direction in a time until the hot melt 43 is solidified.

As illustrated in FIG. 30, a width Ddb of the positioning hole 222q in the longitudinal direction and a width ddb of the snap-fit claw 221p have the following relationship.

Ddb>ddb

Similarly, a width Dda of the positioning hole 222c and a width dda of the positioning boss 221c have the following relationship.

Dda>dda

This is because the snap-fit claw 221p, and the positioning hole 222q, and the positioning hole 222c and the positioning boss 221c do not interfere with each other even if a dimensional difference in the longitudinal direction occurs due to thermal expansion of the developing cover 222 is caused when the hot melt 43 is in a high temperature state. That is, a gap in the longitudinal direction (Yd direction) of a predetermined range for preventing the interference is formed between the positioning boss 221c and the positioning hole 222c and between the snap-fit claw 221p and the positioning hole 222q. As a result, the snap-fit claw 221p and the positioning hole 222q, and the positioning hole 222c and the positioning boss 221c are relatively movable (slidable) within a predetermined range in the longitudinal direction.

Note that, in a case where the component force Fz is small, floating occurs, and in a case where the component force Fz is large, a relative movement between the developer container 21 and the developing cover 22 is hindered, and there is a concern that a force in the longitudinal direction due to thermal expansion of the developing cover 22 is applied to the developer container 121. Therefore, it is necessary to design the snap-fit claw 221p within a range in which both are satisfied. In the present embodiment, the component force Fz is set within a range of 1(N) to 50(N), but may be appropriately set according to the friction coefficient between the locking members.

Further, as illustrated in FIG. 29D, before the snap-fit claw 221p is engaged with the positioning hole 222q (before elastic deformation is started), a height of the positioning boss 221c is set such that fitting of the positioning boss 221c and the positioning hole 222c is started. In this way, before the reaction force of the snap-fit claw 221p is generated, a position of the developing cover 22 in the cross-sectional direction with respect to the developer container 21 (the Xd direction intersecting the joining direction of the developer container 21 and the developing cover 22) is determined first, and thus, assemblability is excellent.

With the above-mentioned configuration, the developer container 21 does not follow the thermally expanded developing cover 22 due to the heat of the hot melt 43, and a dimensional difference therebetween is absorbed, making it possible to perform assembly without affecting the attachment position of the developing blade 17.

### Sixth Embodiment

A configuration and a manufacturing method of a developing unit 15d according to a sixth embodiment of the present invention will be described. Here, points different from the first to fifth embodiments in the sixth embodiment will be described, and description of points common to the first to fifth embodiment in the sixth embodiment will be omitted.

### Fixing of Developer Container and Developing Cover

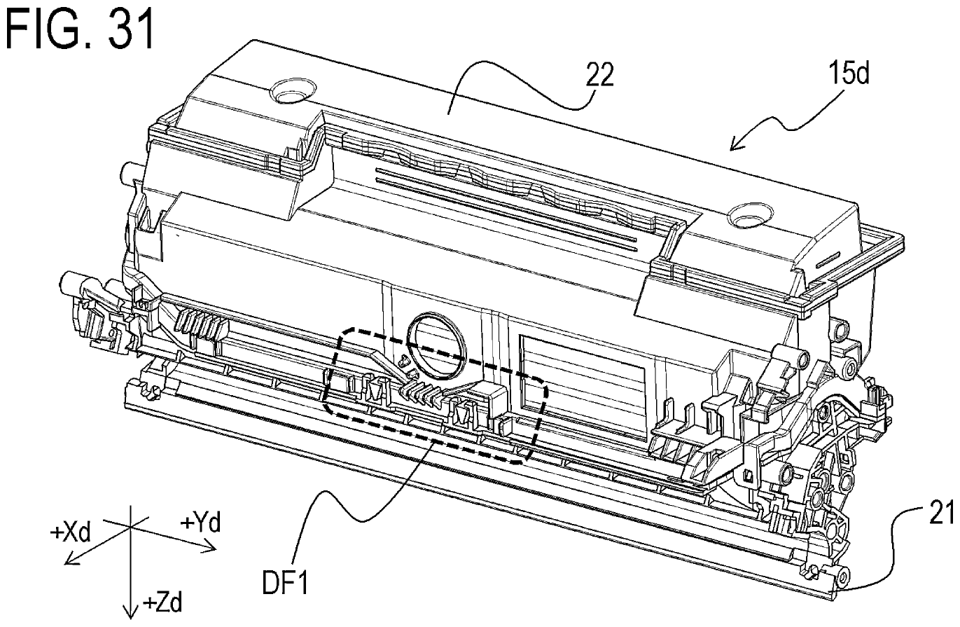

As another embodiment of the method of fixing the developer container and the developing cover, an example in which the direction of bending at the time of engagement with the snap-fit shape portion 21k of the above-described retaining is different will be described with reference to FIGS. 31, 32, 33, 34, and 35.

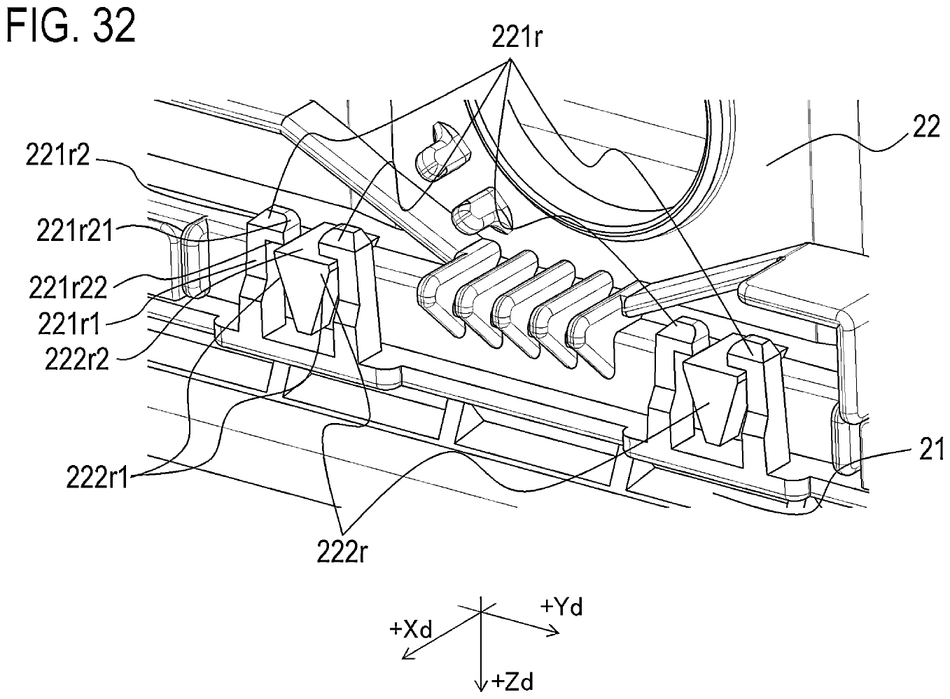

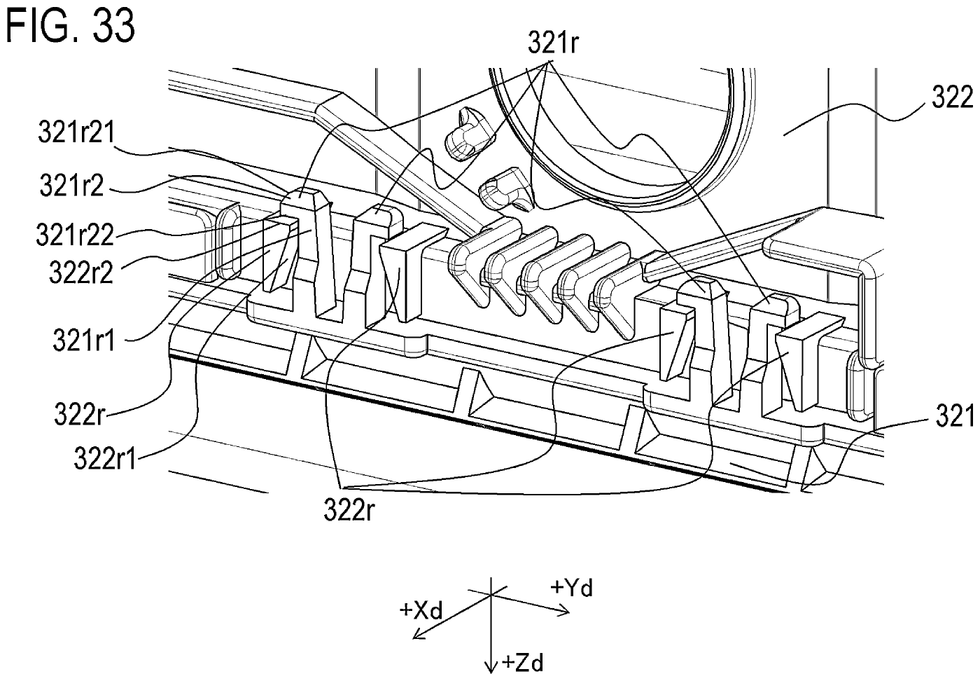

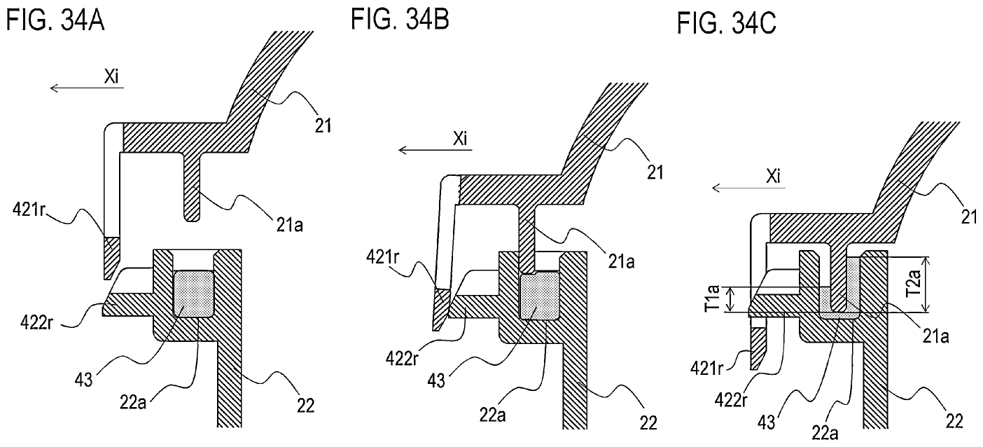

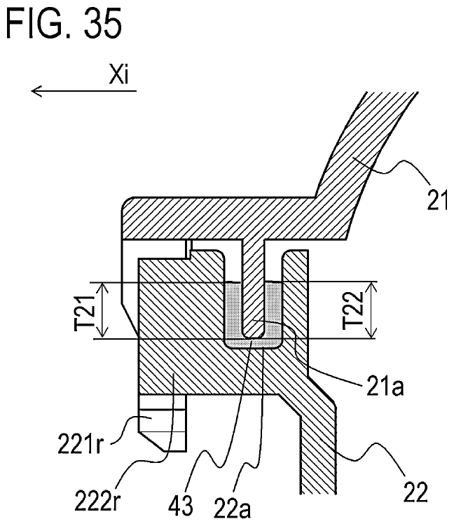

FIG. 31 is an external perspective view of a developing unit 15d in the sixth embodiment, FIG. 32 is an enlarged view of a DF1 portion of FIG. 31, and FIG. 33 is a view illustrating another example of the DF1 portion of FIG. 31. FIGS. 34A, 34B, and 34C are schematic cross-sectional views illustrating a mechanism of scraping the hot melt generated in the engagement configuration by the snap-fit shape portion in a comparative example. FIG. 35 is a schematic cross-sectional view illustrating a mechanism in which scratching of hot melt is reduced by the engagement configuration in the sixth embodiment.

As a member (adhesive) for bonding and joining the developer container 21 and the developing cover 22, the shape and placement of the hot melt 43, which is a viscoelastic body as in the present embodiment, are difficult to determine as compared with a rigid component, and a positional relationship in an assembly operation with a contact counterpart member is important for production stability.

FIG. 32 illustrates positioning portions (an engagement portion and an engaged portion) of the developer container 21 and the developing cover 22 according to the present embodiment. The developer container 21 is provided with a pair of snap-fit shape portions 221r as engaged portions, and the developing cover 22 is provided with a protruding portion 222r as an engagement portion.

Here, the positioning portion illustrated in FIG. 32 is disposed at the central portion in the longitudinal direction of the developing unit 15d, and is disposed outside a line extending in the longitudinal direction of the connection line between the developer container 21 and the developing cover 22. In the connection line extending in the longitudinal direction, a cross-sectional direction in which a protruding shape of the rib (protruding portion) 21a inserted into the groove portion 22a appears coincides with an arrow Xd direction in FIGS. 31, 32, and 33. The direction substantially parallel to the extending direction of the protruding shape coincides with the direction of an arrow Yd in FIGS. 31, 32, and 33.

The pair of snap-fit shape portions 221r has flexibility, and in the present embodiment, the flexible direction at the time of engagement with the protruding portion 222r is the Yd direction.

The snap-fit shape portion 221r includes a pair of arm portions 221r1 arranged in the longitudinal direction of the developing unit 15d and erected so as to extend toward the developer container 21 along the joining direction of the developer container 21 and the developing cover 22. The pair of arms 221r1 includes claw portions (bent portions bent in directions facing each other) 221r2 protruding in directions facing each other at respective tip portions. The pair of snap-fit shape portions 221r is disposed so as to sandwich the protruding portion 222r of the developing cover 22 in the unit longitudinal direction. In addition, a facing gap between the claw portions 221r2 of the pair of snap-fit shape portions 221r is narrower than a width (longitudinal direction width) of the protruding portion 222r in a state where no external force is applied to the snap-fit shape portion 221r. The claw portion 221r2 allows the pair of snap-fit shape portions 221r to engage with the protruding portion 222r so as to hold the protruding portion 222r of the developing cover 22.

With the formation of the engaged state, the relative movement of the developer container 21 and the developing cover 22 in the direction (Zd direction) in which the developer container and the developing cover are separated from each other is restricted, and the relative movement of the developer container 21 and the developing cover 22 in the unit longitudinal direction is restricted to a predetermined range.

Each of the pair of snap-fit shape portions 221r has a force receiving surface 221r21 and an engaging surface 221r22 as a regulating surface or an engaging force applying portion on the claw portion 221r2. The protruding portion 222r has a pair of force applying surfaces 222r1 and an engagement surface 222r2 as a surface to be restricted or an engagement force receiving portion. The force receiving surface 221r21 and the force applying surface 222r1 are surfaces inclined with respect to the joining direction. The force receiving surface 221r21 and the force applying surface 222r1 come into contact with each other in the process of joining the developer container 21 and the developing cover 22, thereby generating a force for deforming the pair of snap-fit shape portions 221r so as to widen the distance therebetween in the unit longitudinal direction. As a result, the claw portions 221r2 of the pair of snap-fit shape portions 221r have an opposing gap wider than the width of the protruding portion 222r, climb over the protruding portion 222r, and the engagement surface 221r22 and the engagement surface 222r2 can be brought into a state of facing and contacting each other in the joining direction. Through such elastic deformation, the snap-fit shape portion 221r and the protruding portion 222r are engaged with each other.

Here, with reference to FIGS. 34A to 34C, the scraping phenomenon of the hot melt 43, which is concerned to occur in the configuration of the comparative example in which the flexible direction of the snap-fit shape portion is different from that of the present embodiment, will be described. The engagement configuration in the comparative example is configured such that the snap-fit shape portion 421r having flexibility in the Xd direction is brought into an engagement state with the engagement portion 321r through elastic deformation in the Xd direction.

As illustrated in FIGS. 34A and 34B, when the snap-fit shape portion 421r is engaged with the engagement portion 422r, the snap-fit shape portion 421r may be bent in the direction of arrow Xi, and the rib (protruding portion) 21a may also be moved and deformed in the direction parallel to the cross section (direction of arrow Xd). At this time, the hot melt 43 is in a state before solidification (for example, a molten state). Then, as shown in FIG. 34B, the rib 21a starts to immerse in the hot melt 43 from a state of moving in the Xi direction. Thereafter, when the engagement between the snap-fit shape portion 421r and the engagement portion 422r is completed, the rib 21a rapidly returns to an original position as illustrated in FIG. 34C. Such returning action of the rib 21a may push out the hot melt 43 in an anti-Xi direction. Hereinafter, such a state change of the hot melt 43 is referred to as scraping.

In particular, in a state where the viscosity of the hot melt 43 is low, this scraping tends to cause imbalance in the immersion amounts T1a and T2a of the hot melt 43 of the rib 21a as illustrated in FIG. 34C. For example, in the case of T1a=0, the joint strength in the Xi direction decreases. Therefore, even in a state where the viscosity of the hot melt 43 is unstable, it is desirable that the difference between the immersion amounts T1a and T2a is as small as possible, and preferably, there is no difference, in order to secure the joint strength and obtain stable productivity.

A characteristic configuration of the present embodiment for realizing this will be described with reference to FIG. 32. As illustrated in FIG. 32, in the present embodiment, the direction in which the snap-fit shape portion 221r bends is the longitudinal direction (arrow Yd direction) of the developing unit 15d. This arrangement configuration is such that a direction in which the snap-fit shape portion 221r bends when locked (direction of arrow Yd) and a direction in which the rib 21a attracts the hot melt 43 (direction of arrow Xi) are orthogonal to each other. With such a configuration, even if the snap-fit shape portion 221r bends in the direction of arrow Yd in FIG. 32 when engaging with the protruding portion 222r, the rib (protruding portion) 21a hardly moves in the direction parallel to the cross section (the direction of arrow Xi in FIG. 34). As a result, the above-described scraping amount can be suppressed to be extremely small.

As shown in FIG. 35, according to the engagement configuration of the present embodiment, even if the immersion amounts T11 and T22 become more equal, and for example, the viscosity of the hot melt 43 varies depending on the production lot, production can be performed in a stable bonded state.

FIG. 33 is a diagram illustrating another example of the engagement configuration of the present embodiment. In the engagement configuration of FIG. 32, a pair of (that is, two) snap-fit shape portions 222r is provided for one protruding portion 221r, but the configuration is not limited thereto. For example, as illustrated in FIG. 33, one snap-fit shape portion 321r may be provided for one protruding portion 322r. The force receiving surface 321r21 in FIG. 33 has the same configuration as the force receiving surface 221r21 in FIG. 32. The engaging surface 321r22 as the regulating surface or the engaging force applying portion in FIG. 33 has the same configuration as the engaging surface 221r22 in FIG. 32. The force applying surface 322r1 in FIG. 33 has the same configuration as the force applying surface 222r1 in FIG. 32. The engagement surface 322r2 as the surface to be restricted or the engagement force receiving portion in FIG. 33 has the same configuration as the engagement surface 222r2 in FIG. 32.

### Seventh Embodiment

A configuration and a manufacturing method of a cleaning unit according to a seventh embodiment of the present invention will be described. Here, differences from the first to sixth embodiments in a seventh embodiment will be described, and description of common points to the first to sixth embodiments in the seventh embodiment will be omitted.

### Fixing of Cleaning Container and Cleaning Cover (Engaging Step)

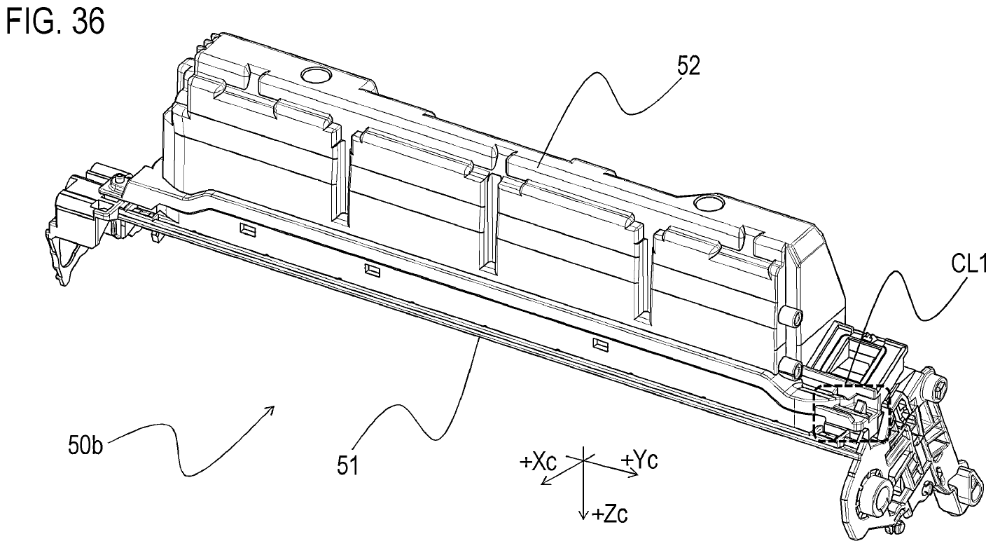

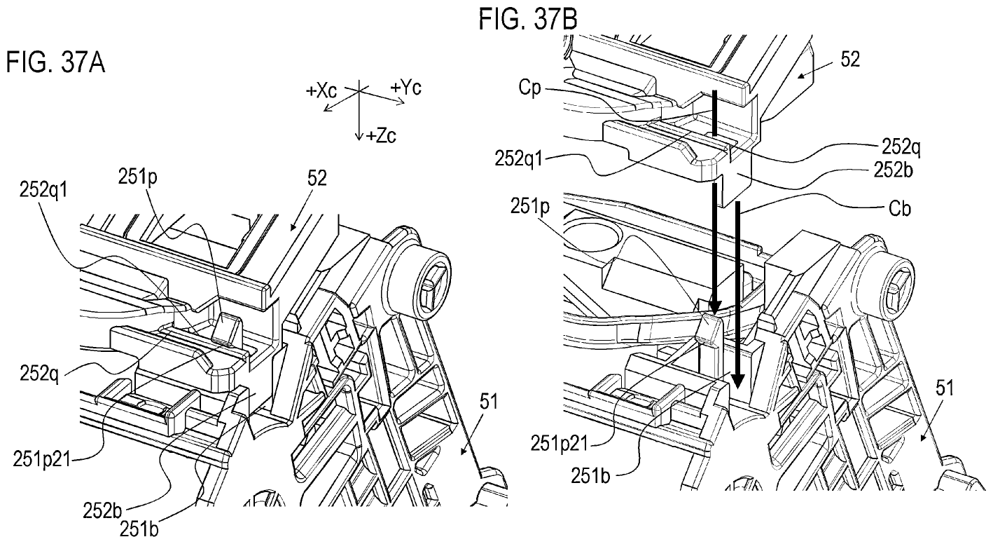

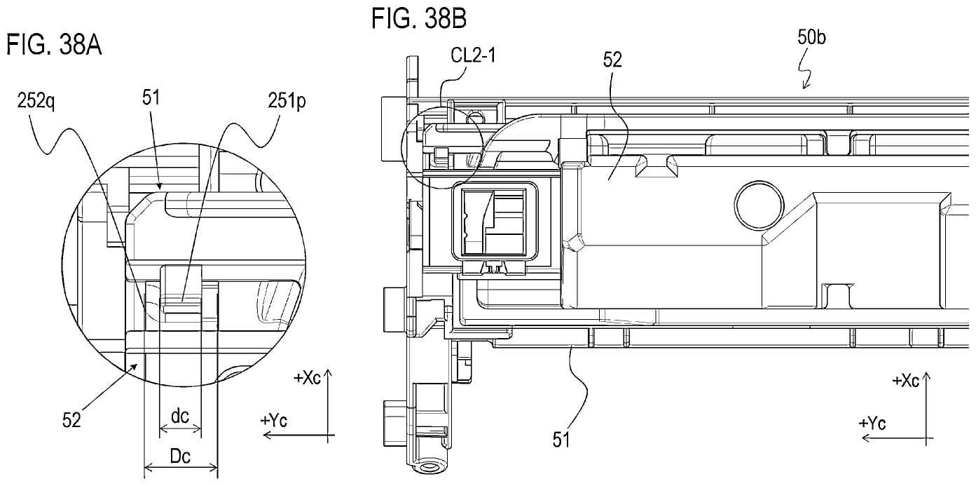

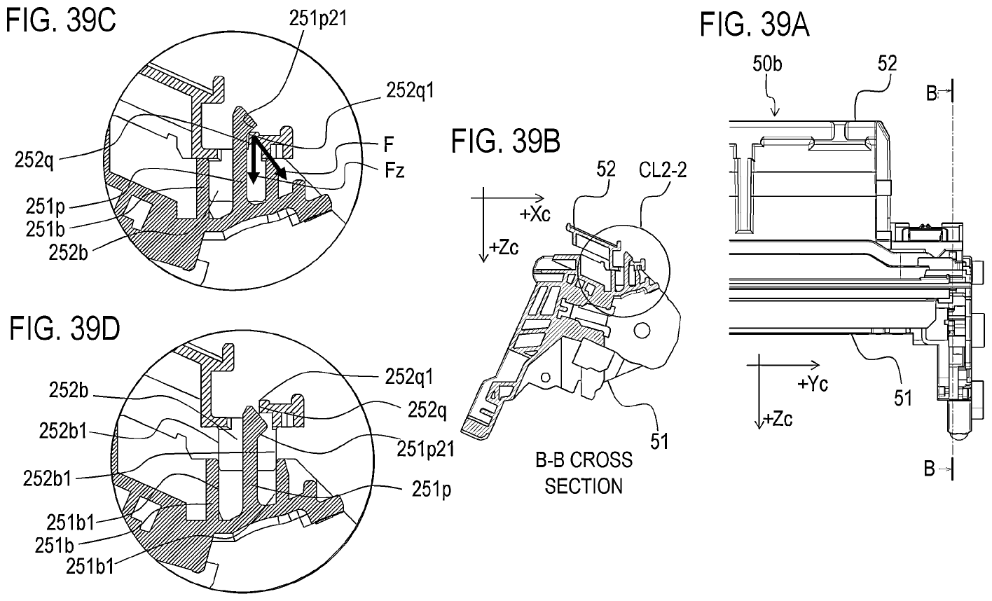

Another embodiment of joining a cleaning cover 52 of a cleaning container 51 will be described with reference to FIGS. 36, 37A, 37B, and 38. FIG. 36 is a perspective view of a cleaning subunit 50b of the cleaning unit according to the seventh embodiment. FIG. 37A is an enlarged perspective view of a CL2 portion in FIG. 36, and is a view illustrating a state in which the cleaning container 51 and the cleaning cover 52 are joined. FIG. 37B is an enlarged perspective view of a CL2 portion in FIG. 36, and is a view illustrating a state before the cleaning container 51 and the cleaning cover 52 are joined. FIG. 38A is an enlarged view of a CL2-1 portion in FIG. 38B, and is an enlarged view of the CL2 portion in FIG. 36 as viewed from above. FIG. 38B is a view of one longitudinal end side of the cleaning subunit 50b as viewed in a direction orthogonal to the longitudinal direction. FIG. 39A is a view of one longitudinal end side of the cleaning subunit 50b as viewed in a direction orthogonal to the longitudinal direction, and is a view as viewed in a direction different from FIG. 38B. FIG. 39B is a cross-sectional view (cross-sectional view taken along arrow B) of one longitudinal end side of the cleaning subunit 50b as viewed in the longitudinal direction (−Yd direction). FIG. 39C is an enlarged view of a CL2-2 portion of FIG. 39B, and is a detailed view illustrating the force of the snap-fit claw 251p. FIG. 39D is an enlarged view of the CL2-2 portion of FIG. 39B, and is a detailed view illustrating a state in the middle of a coupling step between the cleaning container 51 and the cleaning cover 52 and illustrating a state immediately before the snap-fit claw 251p is bent.

As described above, regarding the attachment of the cleaning blade 13, similarly to the attachment of the developing blade 17, the cleaning blade 13 is first assembled to the cleaning container 51. Thereafter, the cleaning cover 52 is attached to the cleaning container 51 using the hot melt 43. Therefore, also in the order of the present manufacturing step, it is necessary to consider that there is no positional fluctuation of the cleaning blade 13 due to the heat of the hot melt 43 at the time of assembly.

Here, in FIGS. 26 to 39, a joining direction (third direction) between the cleaning container 51 and the cleaning cover 52 is defined as a Ze direction. A longitudinal direction (second direction) of the cleaning unit orthogonal to the joining direction is defined as a Yc direction, and a direction (first direction) orthogonal to each of the joining direction and the longitudinal direction is defined as an Xc direction.

As illustrated in FIG. 37, the cleaning container 51 is provided with a positioning recessed portion 251b as a second engagement portion, and the cleaning cover 52 is provided with a positioning protruding portion 252b as a second engaged portion. The positioning protruding portion 252b is provided on the cleaning cover 52 so as to protrude toward the cleaning container 51 in the joining direction of the cleaning container 51 and the cleaning cover 52. The positioning recessed portion 251b is provided in the cleaning container 51 so as to be recessed in a direction away from the cleaning cover 52 in the joining direction. The positioning protruding portion 252b is configured to be fitted into the positioning recessed portion 251b in a state where the cleaning container 51 and the cleaning cover 52 are joined. The positioning recessed portion 251b is open in the unit longitudinal direction (Yc direction). The positioning protruding portion 252b and the positioning recessed portion 251b are in contact with each other in the Xc direction orthogonal (intersecting) to the unit longitudinal direction in the fitted state, and are configured to be relatively movable (slidable) in the unit longitudinal direction. In the fitted state, the positioning protruding portion 252b and the positioning recessed portion 251b allow the relative movement of the cleaning container 51 and the cleaning cover 52 in the longitudinal direction while restricting the relative movement in the Xc direction orthogonal to the longitudinal direction.

As illustrated in FIG. 37, in the cleaning unit of the present embodiment, a snap-fit claw 251p as a fourth engagement portion is provided in the cleaning container 51 as the first frame body. A positioning hole 252q as a fourth engaged portion is provided in the cleaning cover 52 as the second frame body. The engagement configuration between the snap-fit claw 251p and the positioning hole 252q is similar to the engagement configuration between the snap-fit claw 222p and the positioning hole 222q in the fifth embodiment, and the description thereof will be omitted.

As illustrated in FIG. 39C, similarly to the developing unit of the fifth embodiment, the cleaning unit of this embodiment also includes a component force Fz in which the force F due to the reaction force of the bending of the snap-fit claw 251p acts in the direction of drawing the cleaning container 51 and the cleaning cover 52. Further, as illustrated in FIG. 38A, a width Dc of the positioning hole 252q in the longitudinal direction and a width de of the snap-fit claw 251p also have the following relationship similarly to the developing unit of the fifth embodiment.

Dd>dd

Further, as illustrated in FIG. 39D, similarly to the developing unit of the fifth embodiment, before the snap-fit claw 251p is engaged with the positioning hole 252q (before the snap-fit claw 251p starts elastic deformation), each height is set so that the positioning protruding portion 252b and the positioning recessed portion 251b start to be fitted to each other.

With the above configuration, similarly to the developing blade 17, the cleaning blade 13 can also be assembled with high accuracy.

As described above, according to each of the above embodiments, the connection surface (connection line) between the frame bodies can be freely configured. In addition, according to each of the above embodiments, the frame body of the common portion including the developing blade, the cleaning blade, and the like is assembled prior to the joining of the frame bodies, so that the common portion of the manufacturing line of the cartridge can be increased, and the device cost and labor can be reduced. That is, according to the present embodiment, in the setting of the connection surface (connection line) of the frame body, the restriction on the device layout can be reduced, and the joining accuracy can be improved.

Note that the configurations of the above-described embodiments can be combined with each other.

The present disclosure is not limited to the above embodiments, and various changes and modifications can be made without departing from the spirit and scope of the present disclosure. Accordingly, the following claims are appended to make the scope of the present disclosure public.

According to the present invention, the manufacturing cost of the container can be reduced and the assembly accuracy can be stabilized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A container for containing developer, the container comprising:
a first frame body provided with an opening portion, the first frame body having a first surface extending along an edge of the opening portion;
a second frame body connected to the first frame body to cover the opening portion and forming a storage portion for storing developer together with the first frame body, the second frame body having a second surface facing the first surface and extending along a direction in which the first surface extends; and
a connection member connecting the first frame body and the second frame body,
wherein
one of the first surface and the second surface is provided with a protruding portion, an other of the first surface and the second surface is provided with a recessed portion,
wherein the protruding portion is inserted into the recessed portion so that a tip surface of the protruding portion and a bottom surface of the recessed portion are not in contact with each other, and
wherein the connection member is provided between the protruding portion and the recessed portion so as to contact both the tip surface of the protruding portion and the bottom surface of the recessed portion.

2. The container according to claim 1, wherein the first surface faces the second surface with a gap therebetween.

3. The container according to claim 1, wherein the first surface annularly extends along the edge of the opening portion, and
wherein the second surface annularly extends along the first surface.

4. The container according to claim 1, wherein the first surface includes a flat portion and an inclined portion at a position different from the flat portion in a direction along the edge, and
wherein the inclined portion extends in a direction away from the flat portion with respect to a direction orthogonal to the flat portion toward the direction along the edge.

5. The container according to claim 4, wherein the inclined portion includes a curved surface.

6. The container according to claim 5, wherein the inclined portion includes a planar surface provided at a position different from the curved surface in the direction along the edge.

7. The container according to claim 2, wherein the first frame body has a first abutting surface on an outer side of the first surface in a direction from an inside to an outside of the storage portion,
wherein the second frame body has a second abutting surface on an outer side of the second surface in the direction from the inside to the outside of the storage portion, and
wherein a position of the second frame body with respect to the first frame body is determined by abutting the first abutting surface and the second abutting surface.

8. The container according to claim 7, wherein the first abutting surface and the second abutting surface are surfaces extending in a longitudinal direction of the first frame body.

9. The container according to claim 8, wherein the first frame body includes an engagement portion in the vicinity of the first abutting surface,
wherein the second frame body includes an engaged portion in the vicinity of the second abutting surface, and
wherein the engagement portion and the engaged portion are engaged to restrict a relative movement of the first abutting surface and the second abutting surface in a direction intersecting the first abutting surface.

10. The container according to claim 9, wherein
the engagement portion includes:
a first engagement portion disposed on one side in the longitudinal direction; and
a second engagement portion disposed on an other side in the longitudinal direction,
wherein
the engaged portion includes:
a first engaged portion disposed on one side in the longitudinal direction; and
a second engaged portion disposed on the other side in the longitudinal direction,
wherein the first engagement portion and the first engaged portion are engaged to restrict a relative movement of the first frame body and the second frame body in the longitudinal direction and a direction orthogonal to the longitudinal direction and orthogonal to the first abutting surface, and
wherein the second engagement portion and the second engaged portion are engaged to allow the relative movement in the longitudinal direction and the direction orthogonal to the longitudinal direction.

11. The container according to claim 10, wherein the engagement portion further includes a third engagement portion disposed between the first engagement portion and the second engagement portion in the longitudinal direction,
wherein the engaged portion further includes a third engaged portion disposed between the first engaged portion and the second engaged portion in the longitudinal direction, and
wherein the third engagement portion and the third engaged portion are engaged to allow the relative movement in the longitudinal direction and the direction orthogonal to the longitudinal direction.

12. The container according to claim 11, wherein the direction orthogonal to the longitudinal direction includes a first direction along the first abutting surface and a third direction orthogonal to both the first direction and a second direction that is the longitudinal direction.

13. The container according to claim 12, wherein the engagement portion further includes a fourth engagement portion disposed on an other side in the second direction at a position different from a position of the second engagement portion,
wherein the engaged portion further includes a fourth engaged portion disposed on the other side in the second direction at a position different from a position of the second engaged portion,
wherein the fourth engagement portion and the fourth engaged portion are engaged to allow the relative movement in the first direction, the second direction, and the third direction, and
wherein the fourth engagement portion includes an engaging force applying portion, and the fourth engaged portion includes an engaging force receiving portion that contacts the engaging force applying portion in the third direction and is slidable in the second direction.

14. The container according to claim 13, wherein the engaging force applying portion and the engaging force receiving portion are brought into a state of being engaged with each other in a case where at least one of the engagement portion and the engaged portion undergoes elastic deformation in a case where the first frame body and the second frame body are connected.

15. The container according to claim 14, wherein the elastic deformation is deformation in which the engaging force applying portion and the engaging force receiving portion relatively move in the first direction.

16. The container according to claim 15, wherein the second engagement portion has a restriction surface along the second direction and the third direction,
wherein the second engaged portion includes a restricted surface along the second direction and the third direction and faces the restriction surface in the first direction, and
wherein, in a case where the first frame body and the second frame body are connected, before at least one of the fourth engagement portion and the fourth engaged portion is elastically deformed, the restriction surface of the second engagement portion and the restricted surface of the second engaged portion face each other in the first direction.

17. The container according to claim 10, further comprising a developing roller configured to bear developer, the developing roller being rotatably supported by the first frame body, wherein
the relative movement is allowed in a direction that includes a direction along a rotation axis of the developing roller.

18. The container according to claim 10, further comprising a photosensitive drum configured to bear a toner image, the photosensitive drum being rotatably supported by the first frame body, wherein
the relative movement is allowed in a direction that includes a direction along a rotation axis of the photosensitive drum.

19. The container according to claim 1, further comprising a developing roller configured to bear developer, the developing roller being rotatably supported by the first frame body.

20. The container according to claim 1, further comprising:
a photosensitive drum configured to bear a toner image; and
a cleaning member fixed to the first frame body to contact the photosensitive drum,
wherein
the storage portion is configured to store the developer removed from the photosensitive drum by the cleaning member.

21. The container according to claim 1, wherein a Young's modulus of the connection member is lower than a Young's modulus of the first frame body and lower than a Young's modulus of the second frame body.

22. The container according to claim 1, wherein the first frame body and the second frame body are made of resin.

23. The container according to claim 1, wherein the connection member is formed by curing a melted resin.

24. A method for manufacturing a container, the container including a first frame body provided with an opening portion, the first frame body having a first surface extending along an edge of the opening portion, and a second frame body connected to the first frame body to cover the opening portion and forming a storage portion for storing developer together with the first frame body, the second frame body having a second surface facing the first surface and extending along a direction in which the first surface extends, a protruding portion being provided on one of the first surface and the second surface, and a recessed portion being provided on an other of the first surface and the second surface, the method comprising:
a supply step of supplying a molten resin to the recessed portion;
a moving step of moving at least one of the first frame body and the second frame body so that a tip surface of the protruding portion is immersed in the molten resin in the recessed portion, the moving step being subsequent to the supply step; and
a curing step of curing the molten resin, the curing step being subsequent to the moving step.

25. The method for manufacturing a container according to claim 24, wherein in the moving step, the protruding portion is inserted into the recessed portion such that a tip surface of the protruding portion and a bottom surface of the depressed portion are not in contact with each other, and
wherein the molten resin is in contact with both the tip surface of the protruding portion and the bottom surface of the recessed portion after being cured in the curing step.

26. The method for manufacturing a container according to claim 24, wherein in the moving step,
a first abutting surface of the first frame body and a second abutting surface of the second frame body are abutted against each other, and
wherein the first frame body includes an engagement portion,
wherein the second frame body includes an engaged portion, and
wherein the engagement portion and the engaged portion are engaged to restrict separation of the first abutting surface and the second abutting surface.

27. The method for manufacturing a container according to claim 24, further comprising a filling step of filling the storage portion with developer after the curing step.

28. The method for manufacturing a container according to claim 24, further comprising, before the supplying step, an attachment step of attaching a developer regulating member for regulating a layer thickness of a developer borne on a developing roller to a first frame body.

29. The method for manufacturing a container according to claim 24, further comprising an attachment step of attaching a cleaning member for cleaning a photosensitive drum before the supplying step.
